(19) United States
(12) Patent Application Publication
(10) Pub. No.: US 2010/0145843 A1
(43) Pub. Date: Jun. 10, 2010

(54) METHOD AND APPARATUS FOR PRICING TRADE ORDERS TO ONE SIDE OF A MARKET CENTER ORDER BOOK

(75) Inventors: Braden S. Janowski, Tulsa, OK (US); Ryan T. Shepherd, Tulsa, OK (US)

Correspondence Address: TRADEHELM, INC., 5727 S. LEWIS AVE, STE. 500, TULSA, OK, 74105, US

(73) Assignee: TradeHelm, Inc., Tulsa, OK (US)

(21) Appl. No.: 12/475,289

(22) Filed: May 29, 2009

Related U.S. Application Data
(63) Continuation-in-part of application No. 12/331,081, filed on Dec. 9, 2008.

(51) Int. Cl. G06Q 40/00

(52) U.S. Cl. 705/37

(57) ABSTRACT

A collection of one or more trade orders for a financial instrument is priced or re-priced to one side of a market center order book based on a target execution price (representing the least favorable price acceptable for all trade orders of the collection), a book depth (representing the collection's book depth), a total order quantity (representing the total quantity of financial instrument units to be traded), and a maxshow (representing the maximum quantity to be shown on the order book at each price level of the book depth). Any existing orders of the collection that are too close to the current market price or too far from the target execution price are canceled or CXR'd, starting with the closest price level to the current market price for “too close” trade orders and the farthest price level from the Target Execution Price for “too far” trade orders. The oldest of any “too-close” trade orders resting at the same price level are cancelled first in order to maximize queue priority and obtain favorable fill prices, and the newest of any “too-far” trade orders resting at the same price level are cancelled first in order to maximize the likelihood of getting the older orders (which have a higher queue priority) filled at the more favorable too-far price. At each price level of the book depth, the quantity of financial instrument units represented by trade orders of the collection is adjusted as necessary to prevent overfilling the total order quantity.

### FIELD OF THE INVENTION

The present invention is generally directed to trading of financial instruments. More particularly, the invention is directed to a method and apparatus for facilitating the pricing and placing of trade orders for a financial instrument to one side of a market center order book.

### BACKGROUND OF THE INVENTION

Institutional investors (such as investment banks, mutual funds, insurance companies, pension funds, etc.) with large orders to execute are often reluctant to expose the large orders to an open order book in the interest of avoiding an adverse market impact. So called “dark pool” markets are crossing networks available to institutional investors to provide liquidity that is not displayed on the order book. Dark pools allow large block investors to move large numbers of shares without revealing themselves to the open market. Another way in which institutional investors disguise their presence to the open market is to submit an iceberg order, which essentially splits the large order into smaller tranches. In so doing, the investor is able to divide large orders into smaller parts so that the market sees only a small portion of the order at a time—just as the proverbial “tip of the iceberg” is the only visible portion of a huge mass of floating ice. By hiding its large size from the open market, the iceberg order reduces the price movements caused by substantial changes in a security's supply and demand.

Iceberg orders are typically characterized by a Target Price representing the trader's presently desired price, a Show Quantity representing the maximum quantity of the iceberg order to be shown at each price level of the order book, an order Depth representing the maximum number of price levels at which orders for the show quantity may rest, and a Total Order Quantity representing the total quantity of the iceberg order. For example, a trader may submit an iceberg order to buy a Total Order Quantity of 5,000 units of a security with a Show Quantity of 50, a Depth of 5, and a Target Price of 100. The iceberg will cause any number (≧1) of Bid orders per price level (not to exceed Show Quantity) to be placed at up to 5 price levels (depending on available quantity) with the total quantity shown at each price level not exceeding the Show Quantity of 50. Any fills are immediately replenished from the hidden quantity of the iceberg order. To obtain the most favorable fill prices, iceberg traders will typically price the orders away from the security's current market price. In addition, iceberg traders typically re-price resting trade orders when market conditions change in a way that leads the trader to conclude that resting orders should be re-priced, such as a change in the current market price of the security.

Multi-leg instruments are similar to iceberg orders in that they too can be traded in a way that results in a collection of trade orders resting on one side of the order book. As with iceberg orders, traders of multi-leg instruments often desire to re-price resting orders for the various leg instruments as market conditions change. Unfortunately, the process of dynamically re-pricing a collection of trade orders resting on one side of the order book (including those submitted for multi-leg instruments, iceberg orders, and any other execution strategy that involves a collection of resting trade orders on one side of the order book) can be challenging. For example, it is difficult for a trader to effectively monitor changing market conditions and re-price resting orders for each of the various leg instruments of a multi-leg instrument, particularly in fast moving markets. Order messaging rules designed to encourage liquidity further strain the ability of the trader to achieve optimal re-pricing at minimal exchange fee cost. If the trader simply cancels resting orders and replaces them with new orders at updated prices, the trader will likely incur punitive exchange fees that can significantly affect profits. In addition, such a simplistic approach to re-pricing overlooks advantages that can be obtained through attention to queue priority and is unlikely to result in getting orders filled at the best possible prices, and could even result in overfills.

What is needed, therefore, is a method and apparatus that facilitates a trader's ability to price and re-price a collection of trade orders to one side of a market center order book and obtain a desired position in a financial instrument at favorable fill prices with no risk of being overfilled.

### SUMMARY OF THE INVENTION

The present invention can be summarized as a method for trading a multi-leg financial instrument. The method includes pricing and placing a collection of one or more trade orders for a financial instrument to one side of a market center order book. The method includes receiving an instruction to price said collection of one or more trade orders to one side of a market center order book. The instruction may be sent in response to a market update reflecting a new market price for the financial instrument. The collection of one or more trade orders is characterized by a Target Execution Price representing the least favorable price acceptable for all trade orders of the collection, a TotalOrderQty representing the total quantity of financial instruments to be traded, a BookDepth representing the total number of consecutive price levels, beginning at the Target Execution Price, at which trade orders of the collection are to be submitted, a MaxShow representing the maximum quantity to be shown on the order book at each level of the BookDepth, a FilledQty representing the aggregate amount of the TotalOrderQty confirmed as being filled, a RemainingQty representing the difference between the TotalOrderQty and the FilledQty, a LevelQty representing a total of the quantity accounted for at the current price level, a DesiredQty representing the lesser of MaxShow and RemainingQty minus MaxShow multiplied by the number of price levels away from the Target Execution Price, a PendingQty representing the maximum amount of the TotalOrderQty that has not been filled but could potentially get filled at any time, and includes the quantity of any trade orders of the collection for which a Cancel order is pending, and in the event In-flight Fill Messaging (IFM) is not available from the market center, further includes both the new and old quantity of any trade order of the collection re-priced via a Cancel and Replace (CXR) order minus 1, and an AvailableQty representing RemainingQty minus PendingQty. In response to the pricing instruction, all “too close” trade orders of the collection resting at a price level that is closer to the current market price than the Target Execution Price are cancelled, all “too far” trade orders of the collection resting at a price level that is farther from the Target Execution Price than the BookDepth are removed (such as by CXR or Cancel), and the total quantity of financial instrument units at each price level of the BookDepth are adjusted, as needed, so that the total quantity at each price level of the BookDepth is no greater than DesiredQty.

Preferably, the method is repeated until FilledQty equals TotalOrderQty, or until the collection is cancelled.

When cancelling trade orders that are too close to the current market price, if there are multiple price levels containing “too close” trade orders, then the trade orders that are resting at the price level that is closest to the market price are cancelled first. Regardless of the number of price levels containing “too close” trade orders, if there are multiple “too close” trade orders resting at the same price level, the orders are cancelled in order of age with the oldest of the “too close” orders resting at the same price level being cancelled first since these trade orders are most likely to get filled first. By cancelling the oldest of any too close trade orders first, the trader minimizes the probability that too close orders will get filled before they are cancelled. When removing trade orders that are too far from the Target Execution Price, if there are multiple price levels containing “too far” trade orders, then the trade orders that are resting at the price level that is farthest from the Target Execution Price are removed first. Regardless of the number of price levels containing “too far” trade orders, if there are multiple “too far” trade orders resting at the same price level, the orders are removed in order from least likely to get filled (in the event of a full book sweep) to most likely to get filled. Since the newest of any such “too far” orders have lower queue priority and are least likely to get filled, the newest “too far” orders at each price level are removed first since these trade orders are least likely to get filled first. By removing the newest of any too far trade orders first, the trader maximizes the probability that too far orders will get filled before they are removed. The trader does not mind, and in fact would prefer, that too far orders get filled before they are cancelled since too far orders are at a more favorable price than orders that are not too far.

The quantity at each price level of the BookDepth can be adjusted in a number of ways. For example, a price level of the BookDepth that includes too much quantity would be adjusted by cancelling any quantity that exceeds DesiredQty. If a price level includes too little quantity, the quantity is adjusted by placing a new order with an amount that equals the lesser of AvailableQty and DesiredQty minus LevelQty. A price level with too little quantity can also be adjusted by submitting a Cancel or Replace (CXR) order with the new quantity for the CXR order being equal to this same quantity (i.e., the lesser or AvailableQty and DesiredQty minus LevelQty).

The present invention also provides an apparatus for pricing and placing a collection of one or more trade orders for a financial instrument to one side of a market center order book in accordance with the method set forth above.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawing (which are not to scale) where:

FIG. 1 is a diagrammatic view of a computer-implemented apparatus suitable for defining and executing a multi-leg financial instrument;

FIG. 2 is a function block diagram of a programmable processing device shown in FIG. 1;

FIGS. 3A and 3B, collectively, are a flow diagram of a method for creating a multi-leg instrument;

FIG. 4 is a screenshot of a screen for defining a multi-leg instrument and market data for the multi-leg instrument;

FIG. 5 is a screenshot of a screen for adding a leg instrument to the market data generation formulas of FIG. 4;

FIG. 6 is a screenshot of a screen for selecting operators to include in the market data generation formulas of FIG. 4;

FIG. 7 is a screenshot of a screen for selecting analytics to include in the market data generation formulas of FIG. 4;

FIG. 8 is a screenshot of a screen for adding a non-leg instrument to the market data generation formulas of FIG. 4;

FIGS. 9A-9F, collectively, are a flow diagram showing a process for executing a multi-leg instrument;

FIG. 10 is a screenshot of a graphical user interface for trading a multi-leg instrument;

FIG. 11 is a screenshot of a screen showing market data and resting trade orders for three native leg instruments that comprise a multi-leg instrument;

FIG. 12 is a screenshot of a screen showing a multi-leg order clerk for monitoring and controlling trade orders related to execution of a multi-leg instrument; and

FIGS. 13A-13C, collectively are a flow diagram showing a process for pricing and placing a collection of one or more trade orders to acquire a position in a financial instrument.

### DETAILED DESCRIPTION OF THE PREFERRED EMBODIMENT

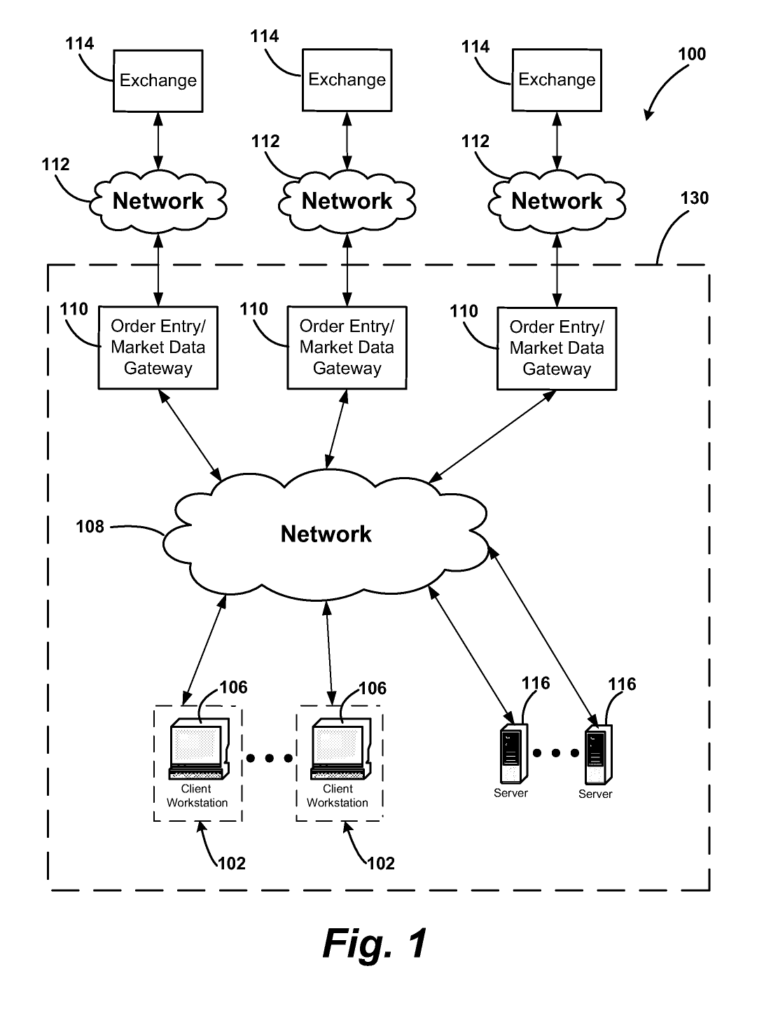

Turning now to the drawings wherein like reference characters indicate like or similar parts throughout, FIG. 1 shows a computer-implemented apparatus 100 suitable for defining and trading a multi-leg financial instrument. The apparatus 100 and the method implemented thereby facilitate the ability of traders to successfully implement multi-leg trading strategies while minimizing so-called “leg risk” where market conditions inhibit the ability to get all legs filled at favorable prices. Leg risk can occur when one or more legs of the multi-leg instrument are fully or partially filled and one or more remainder legs (i.e., legs that are not fully filled) are unable to get filled at the desired price. Since the success of the multi-leg strategy is largely dependent on getting all legs fully filled at the prices desired by the trader according to the multi-leg strategy, the trader's risk is increased for any unfilled (i.e., either partially unfilled or totally unfilled) when one or more of the unfilled legs are unable to be filled at the strategized leg price. The apparatus 100 and associate method described herein employs a unique multi-attempt approach to reduce leg risk by maximizing queue priority and obtaining favorable fills on remainder legs that result from a fractional-fill first attempt.

It is important to note at the outset that the multi-leg instrument is not an exchange-provided instrument. Rather, it is a synthetic instrument defined by a trader according to the trader's multi-leg trading strategy. The synthetic multi-leg instrument includes two or more legs where each leg represents a financial instrument (leg instrument), a price (leg price) for the financial instrument, and a quantity (leg quantity) of the financial instrument that comprises one unit of the multi-leg instrument. Being a synthetic instrument, the multi-leg instrument has a synthetic price represented by a multi-leg definition that equates the synthetic price for one unit of the multi-leg instrument to an aggregation of items including but not limited to the leg price and leg quantity of each leg. Each leg of the multi-leg instrument can include any financial instrument that is tradable by price and quantity, including but not limited to native exchange-provided instruments, synthetic instruments, and other multi-leg instruments (i.e., a nested multi-leg instrument).

The apparatus 100 includes one or more client workstations 102 having a graphical user display, a human interaction device (such as a computer monitor with keyboard and/or mouse) and a client processing device (shown collectively at 106), which may be a dedicated client computer for each client workstation 102 as shown in FIG. 1 or a single computing device networked to each of the client workstations 102. Each trader terminal 102 is configured for electronic communication with an electronic exchange 114 (or other market center) by way of a communication network 108, which may be either a totally wired network or one that is configured to enable at least some components to communicate wirelessly. Trade orders submitted from a client workstation 102 are routed through network 108 where order entry gateways and market data gateways 110 for each exchange 114 receive the trade orders and place them in the proper electronic format according to protocol required by the particular exchange 114. Order entry/market data gateways 110 may be optionally installed in separate hardware, such as one or more servers 116 that are components of network 108, or gateways 110 may be installed in the client workstations 102. The client workstations 102, network 108, servers 116 and order entry and market data gateways 110 are typically elements within the trader's system 130, while networks 112 and exchanges 114 are external to the trader's system. Trade orders are received by an exchange 114 via a communication network 112. A live market data feed 110 is provided to enable traders to view and/or utilize live market data as needed to implement a trader's strategy.

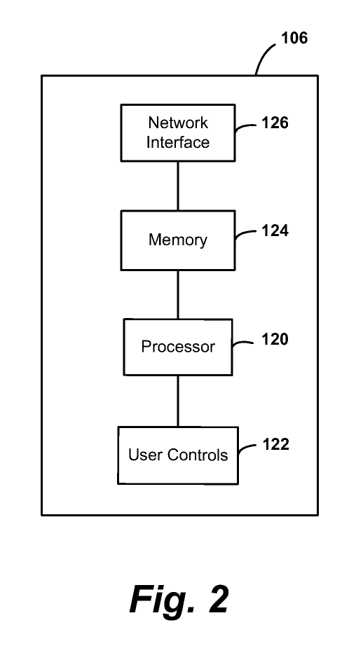

FIG. 2 shows the basic hardware associated with each of the client processing devices 106 shown in FIG. 1. The device 106 includes a programmable electronic processing device 120 (such as a dual quad core Xeon™ E-5420 processing device provided by Intel™) in communication with the display device 104 (FIG. 1), a user input device 122 (such as a computer mouse with buttons and/or a computer keyboard), and a network interface 126 for sending and receiving communications from network 108 (FIG. 1). The client processing device 106 (or other programmable processing device, such as servers 116, that is in communication with the trader terminal 102 of FIG. 1) is programmed to enable a trader to define a multi-leg instrument and to execute the legs of the instrument on one or more electronic exchanges. Programming for processing device 106 may be stored in electronic memory 124, which may include RAM (random access memory), ROM (read only memory), or other suitable form of memory. Alternatively, programming for defining and trading a multi-leg instrument may implemented in one or more servers 116 that are in communication with device 106 via network 108.

As earlier stated, each multi-leg instrument is comprised of two or more legs where each leg represents a financial instrument, or leg instrument with a leg price and a leg quantity. A multi-leg definition that takes into account the leg price and leg quantity of each leg (as well as other items if desired) is used to determine a synthetic price for the multi-leg instrument. A leg submittal trigger, representing one or more requirements that must be met before a trade order for the leg instrument can be submitted to an exchange, is determined for each leg. While spread trading is normally associated with multi-leg trading strategies, the present invention is not limited to spread trading. The implementation of a variety of multi-leg strategies may be facilitated by the present invention.

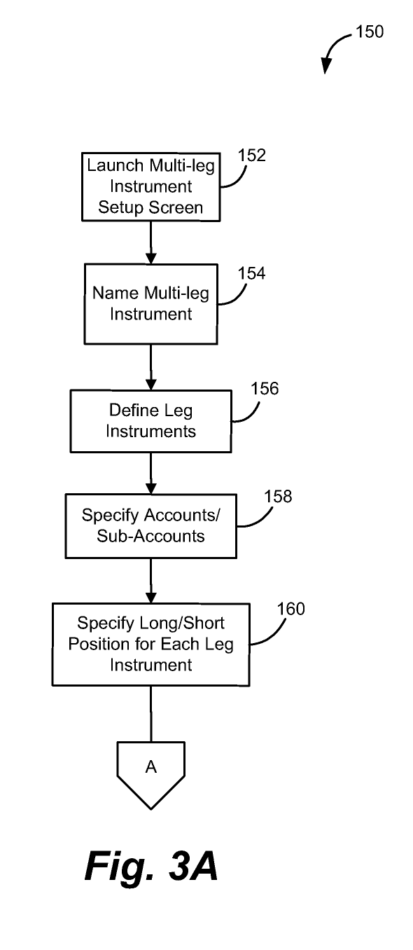

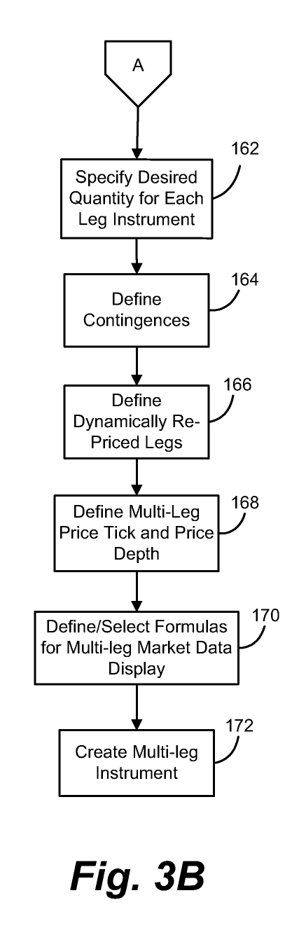

A computer-implemented method 150 for defining a multi-leg instrument to implement a multi-leg trading strategy is shown in FIGS. 3A and 3B. From a trader terminal 102 (FIG. 1), the trader launches a multi-leg setup screen or GUI (graphical user interface) 152 which the trader uses to define various parameters/characteristics of a multi-leg instrument having two or more legs where each leg represents a financial instrument, or leg instrument. Using the setup screen, the trader names the multi-leg instrument 154, defines each leg instrument 156, and optionally specifies accounts and sub-accounts 158 for each leg. The trader also specifies either a long or short position for each leg instrument 160, specifies a desired leg quantity for each leg instrument 162, and defines which leg instruments (if any) will be contingent on the execution of other leg instruments (if any) 164. The trader also defines whether any leg instruments will be dynamically re-priced when market updates are received 166.

With continued reference to FIGS. 3A and 3B, a price tick and price depth are preferably defined to enable generation of an aggregated market data display of the synthetic multi-leg instrument 168. If a multi-leg market data display is to be generated, algorithms for generating the synthetic multi-leg market data are defined/selected 170. Finally, the multi-leg instrument is created 172.

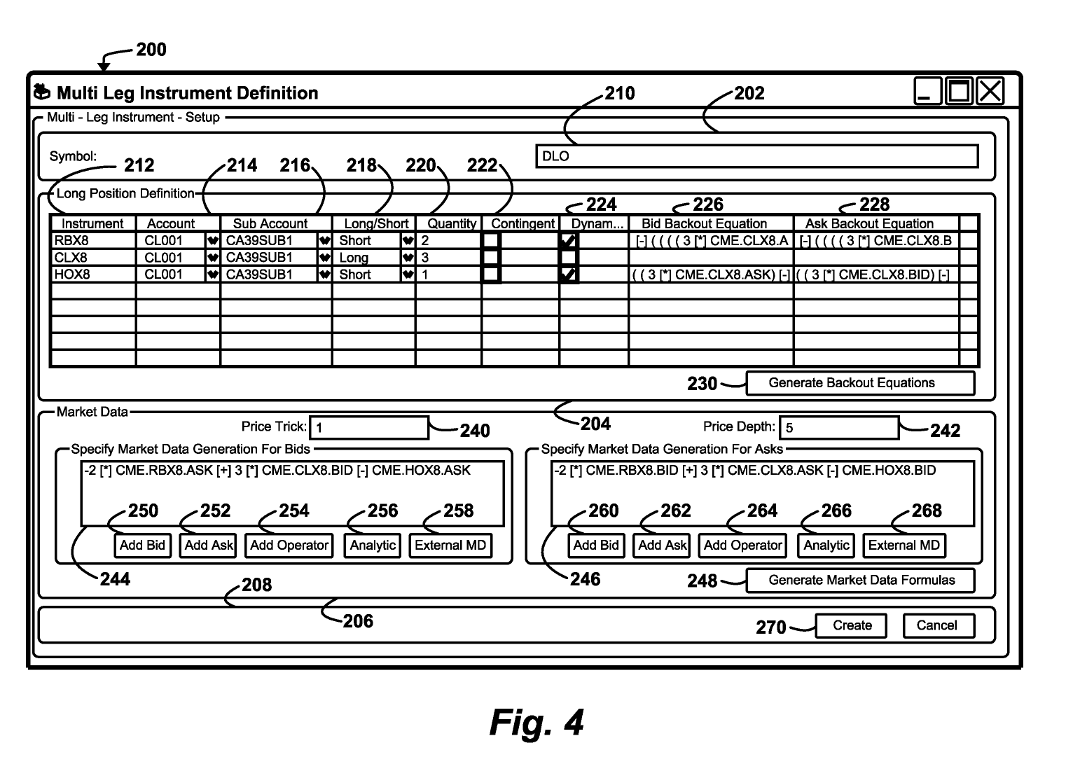

In an exemplary implementation of the multi-leg instrument definition process of FIGS. 3A and 3B, FIG. 4 shows a screenshot of a multi-leg instrument definition screen 200 that is presented at a trader terminal 102 (FIG. 1) when the trader launches a multi-leg instrument setup process. In a preferred embodiment, screen 200 is launched in conjunction with or as an integral component of a trading platform (such as the ACtrader™ trading platform, which is available for license from TradeHelm, Inc. of Tulsa, Okla.) through which trade orders for the multi-leg instrument are submitted to one or more electronic exchanges. The multi-leg instrument definition screen 200 shown in FIG. 4 is divided into four user input areas, including an instrument naming area 202 for naming the multi-leg instrument being created, a multi-leg unit definition area 204 for defining the financial instrument and characteristics of the financial instrument that will comprise each of the two or more legs, a market data definition/generation area 206 for defining market data generation at the multi-leg instrument level, and a multi-leg instrument creation/cancelation area 208 that allows the trader to either create the multi-leg instrument as defined by areas 204, 206 and 208, or to cancel same.

The trader names the multi-leg instrument in Symbol field 210. For this example, the trader has named the multi-leg instrument “DLO”. In multi-leg unit definition area 204, the trader defines each leg of the multi-leg instrument/unit. Here, the trader has defined three legs with each leg including a financial instrument as specified in Instrument column 212. An Account and Sub-Account on which each leg will be traded may be designated in columns 214 and 216, respectively. Long/Short column 218 allows the trader to specify the position each leg instrument will assume when a trade order is submitted using the multi-leg instrument. A Quantity column 220 is provided for specifying the quantity of each leg instrument to be traded. Contingent column 222 provides the trader with the option to make a leg instrument dependent upon another leg instrument such that a trade order for a contingent leg instrument will not execute until trade orders for all dependent leg instruments are executed. This feature is particularly useful in situations where a leg instrument is traded in a less liquid market than the other leg instrument. By making the more liquid leg instrument(s) contingent on execution of the less liquid instrument, the trader increases the likelihood of getting all leg instruments filled. At least one leg must be non-contingent. In the event the trader attempts to make all legs contingent, the apparatus 100 will present the trader with a pop-up window or other message advising that at least one leg instrument must be non-contingent. If the trader wishes to have pricing dynamically re-calculated as market conditions change, the trader may indicate such in Dynamic Recalculation column 224. As described in greater detail below, dynamic re-calculation/re-pricing enables resting trade orders for leg instruments to be re-priced or adjusted when a market update is received via a market data feed 110. Accordingly, backout equations for pricing both the Bid and Ask sides for each leg instrument configured for dynamic re-pricing must be specified in columns 226 and 228, respectively. When a market update is received, the backout equations are used to determine a new/updated leg price.

While the Bid and Ask backout equations for columns 226 and 228 may be defined by the trader, in a preferred embodiment these equations are programmatically determined by solving a multi-leg definition representing a synthetic price of the multi-leg instrument as a function of an aggregation of items that include the leg prices and leg quantities. Accordingly, a synthetic price for the multi-leg instrument can be represented by the following multi-leg definition for the DLO instrument that equates one unit of the synthetic DLO instrument to an aggregation of items including the leg price and leg quantity of each leg:

MLprice=−2A+3B−IC

where:

A=Best Ask price for leg instrument RBX8 at the desired quantity of 2 (since RBX8 has a “short” position, Best Ask is used to represent a “sell” price);

B=Best Bid price for leg instrument CLX8 at the desired quantity of 3 (since CLX8 has a “long” position, Best Bid is used to represent a “buy” price); and

C=Best Ask price for leg instrument HOX8 at the desired quantity of 1 (since HOX8 has a “short” position, Best Ask is used to represent a “sell” price). Solving the above multi-leg definition for each leg instrument price yields the following backout equations for the three legs:

A=(−MLprice+3B−1C)/2;

B=(MLprice+2A+C)/3; and

C=−MLprice−2A+3B.

These backout equations are used to calculate the leg instrument prices including dynamically re-priced legs, and for dynamically re-priced legs they are re-calculated each time a market update is received for any instrument price that is included in the backout equation. The above backout equations are generated programmatically by processing device 106 when the trader clicks the Generate Backout Equations button 230. If desired, the trader can edit or otherwise adjust the automatically generated backout equations.

Market data definition and market data generation for the multi-leg instrument are defined at area 206. Market data definition includes defining the multi-leg instrument book by specifying a Price Tick at field 240 and a Price Depth at field 242, while market data generation determines how the book will appear based on user-defined/specified market data computational formulas made for the Bid and Ask sides in fields 244 and 246, respectively. These computational formulas can use a combination of Bid/Ask market data, user-defined/specified analytics, and external market data. The formulas combine with the market data definition to produce all the parameters needed to generate a graphical user trading interface for the synthetic multi-leg instrument.

When defining market data generation in fields 244 and 246, the trader may define the computational formulas by use of the rows of buttons located below fields 244 and 246. Alternatively, the trader may have processing device 106 auto-generate the computational formulas by simply clicking the Generate Market Data Formulas button 248. When automatic generation of the formulas is used, the formulas are automatically generated from the multi-leg unit definition parameters specified in definition area 204. The trader can also edit or otherwise adjust the automatically generated formulas if desired. For example, using the parameter settings shown in definition area 204, it can be seen that the multi-leg instrument is comprised of three financial instruments (as shown in column 212), including instruments represented by the symbols RBX8 (Gas/Oil Futures Contract), CLX8 (Light Sweet Crude Oil Futures Contract) and HOX8 (Heating Oil Futures Contract). It can further be seen that the desired position for RBX8 is “short” and the desired quantity is “2”, the desired position for CLX8 is “long” and the desired quantity is “3”, and the desired position for HOX8 is “short” with a desired quantity of “1”. In a sense, the generated formulas for both Bid (field 244) and Ask (field 246) are an aggregation of the three legs and/or any other items the trader desires to include. A short position is in inverse relation to a long position, and this inverse relationship is reflected in the formulas by assigning a negative value to a leg that has a short position and a positive value to a leg that has a long position. For each leg having a short position, the Bid formula of field 244 multiplies the negative of the value shown in Quantity column 220 by the Best Ask price for the leg instrument. And for each leg having a long position, the Bid formula of window 244 multiplies the positive of the value shown in Quantity column 220 by the Best Bid price for the leg instrument. Applying the above, the auto-generated market data generation formula for the Bid side is as follows:

−2(CME.RBX8.ASK)+3(CME.CLX8.BID)−1(CME.HOX8.ASK)

where:
CME.RBX8.ASK=Best Ask (for leg instrument RBX8);
CME.CLX8.BID=Best Bid (for leg instrument CLX8); and
CME.HOX8.ASK=Best Ask (for leg instrument HOX8).
   The market data generation formula for the Ask side is as follows:

−2(CME.RBX8.BID)+3(CME.CLX8.ASK)−1(CME.HOX8.BID)

where:
CME.RBX8.BID Best Bid (for leg instrument RMX8);
CME.CLX8.ASK Best Ask (for leg instrument CLX8); and
CME.HOX8.BID Best Bid (for leg instrument HOX8).

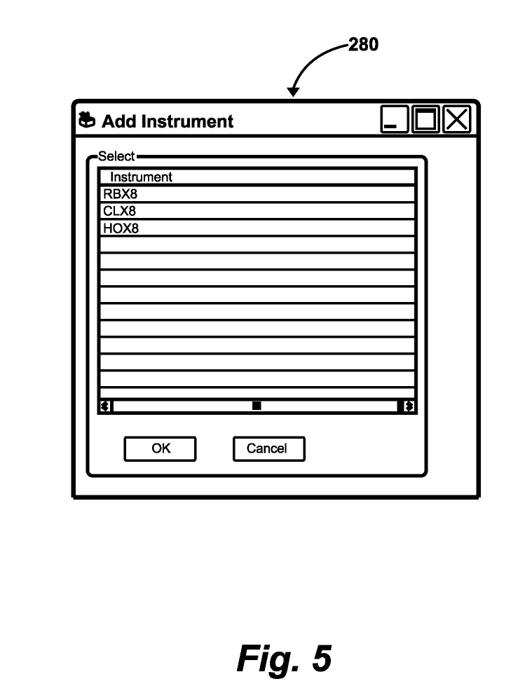

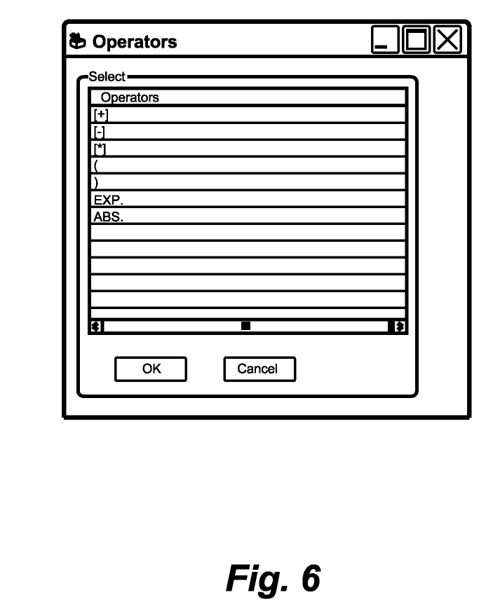

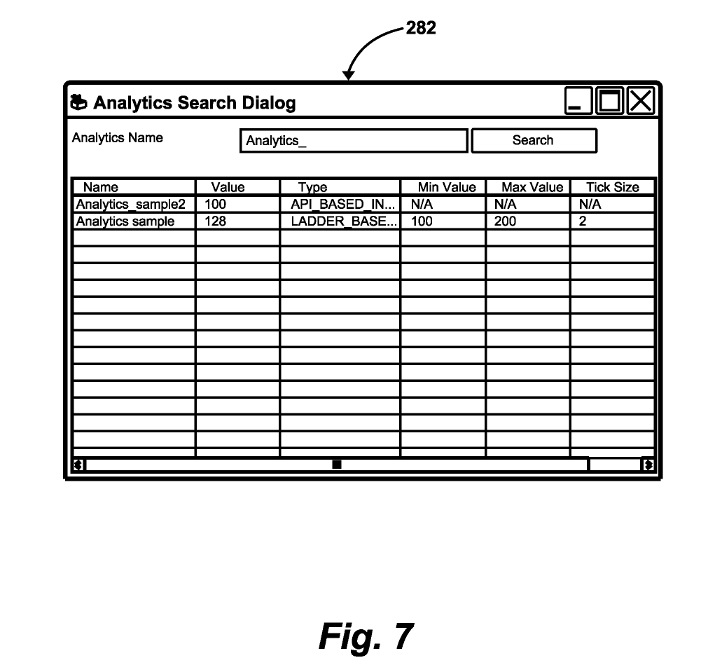

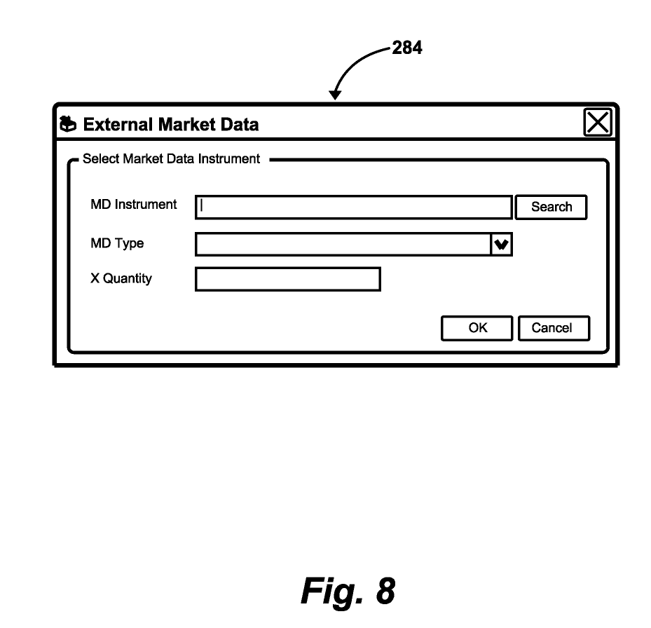

If the trader chooses to define the market data generation formulas, the trader may do so with the use of the buttons located below fields 244 and 246. When the trader clicks either of the Add Bid buttons 250, 260 or the Add Ask buttons 252, 262, an “Add Instrument” window 280 appears as shown in FIG. 5. The trader can then choose to include market data from one of the listed instruments and it will be added to the market data generation equation in field 244 (when building a formula for the Bid side) or field 246 (when building a formula for the Ask side). Logical operators, including+(addition),−(subtraction), *(multiplication), open parenthesis “(”, close parenthesis “)”, EXP (exponential), and ABS (absolute value), are added to the formulas by clicking the Add Operator button 254, 264 and then choosing from the displayed operators shown in FIG. 6. Clicking the Analytics button 256, 266 opens an “Analog Search Dialog” window 282 as shown in FIG. 7 where the trader can choose from a list of previously created user-defined analytics, or alternatively, to create a new analytic. Selecting the External MD (market data) button 258, 268 opens an “External Market Data” window 284 as shown in FIG. 8, where the trader can choose to include external market data from any existing native, synthetic or multi-leg instrument.

Upon completion, the trader clicks Create button 270 to create the multi-leg instrument as defined. At this point, both the Bid and Ask side market data generation fields 244, 246 should contain formulas. If one or both of the formulas are not entered, processing device 106 will generate an error message and not allow the multi-leg instrument to be created until the necessary input has been made.

A preferred method of executing the multi-leg instrument in accordance with programming for processing device 106 or other suitable processing device will now be described. With the multi-leg instrument created, processing device 106 is programmed to execute the multi-leg instrument in accordance with a method intended to maximize the likelihood of successfully filling all legs at favorable prices and low exchange fees while minimizing leg risk. The precise method of execution will vary according to how the multi-leg instrument is configured, particularly with regard to leg submittal triggers which represent one or more requirements that must be met before a trade order for the leg instrument can be submitted to an exchange. Leg submittal triggers include configuring the leg for dynamic re-pricing (see column 224 of FIG. 4), which is essentially a “no wait” requirement that immediately submits a limit trade order to an exchange at a leg price and for the full leg quantity upon initiating execution of the multi-leg instrument. By queuing DLO legs quickly, queue priority is maximized, which increases execution speed and minimizes leg risk. Another example of a leg submittal trigger is a contingent (see column 222 of FIG. 4), which essentially is a “wait” requirement that delays submittal of a trade order until all contingency requirements have been met. A common contingency requirement is to make the submittal of a trade order contingent on all other non-contingent legs having been fully filled. This type of leg submittal trigger is particularly useful in reducing leg risk when the contingent leg is in a more liquid market than the non-contingent legs. Trade orders for contingent legs (including legs configured for dynamic re-pricing) are held in abeyance until all contingencies have been met. Trade orders for non-contingent dynamically re-priced legs are submitted immediately at a desired leg price and quantity. For legs that are non-contingent and non-dynamically re-priced, the leg submittal trigger is essentially a “wait” requirement that delays submittal of a trade order for the leg instrument until current market activity shows that each leg is available at the leg price and leg quantity. Trade orders for these legs are preferably internally queued and submitted to an exchange (such as an electronic exchange, ECN, or broker) when the market crosses the leg price and quantity of the multi-leg instrument (i.e., when current market data reflects that the multi-leg instrument, and hence all legs thereof, is available for acquisition at the desired leg price and quantity). By “internally queue”, what is meant is that the parameters of the trade order (including price, quantity, and order type) are set by processing device 106 such that the trade order can be quickly and efficiently submitted to an exchange when all required conditions have been met. Each leg of the instrument is considered to be “available” when current market activity shows that the specified leg quantity of the respective trade order can be fully filled at a current market price that is equal to or more favorable than (i.e., at or above a desired Ask price and at or below a desired Bid price) the leg price. By placing orders when the market crosses, the trader greatly increases the likelihood of getting all leg orders filled for the full quantity so that leg risk is minimized. For non-continent, dynamically re-priced legs, the leg submittal trigger is essentially a “no wait” requirement that immediately submits a trade order to an exchange at the leg price and leg quantity upon initiating execution of the multi-leg instrument. For any leg which is not fully filled after an initial trade order for that leg is submitted, a subsequent trade order will be sent for the remaining leg quantity at a leg price that is determined based on the fill price of all fully and partially filled legs, provided the multi-leg instrument is still available at a favorable price.

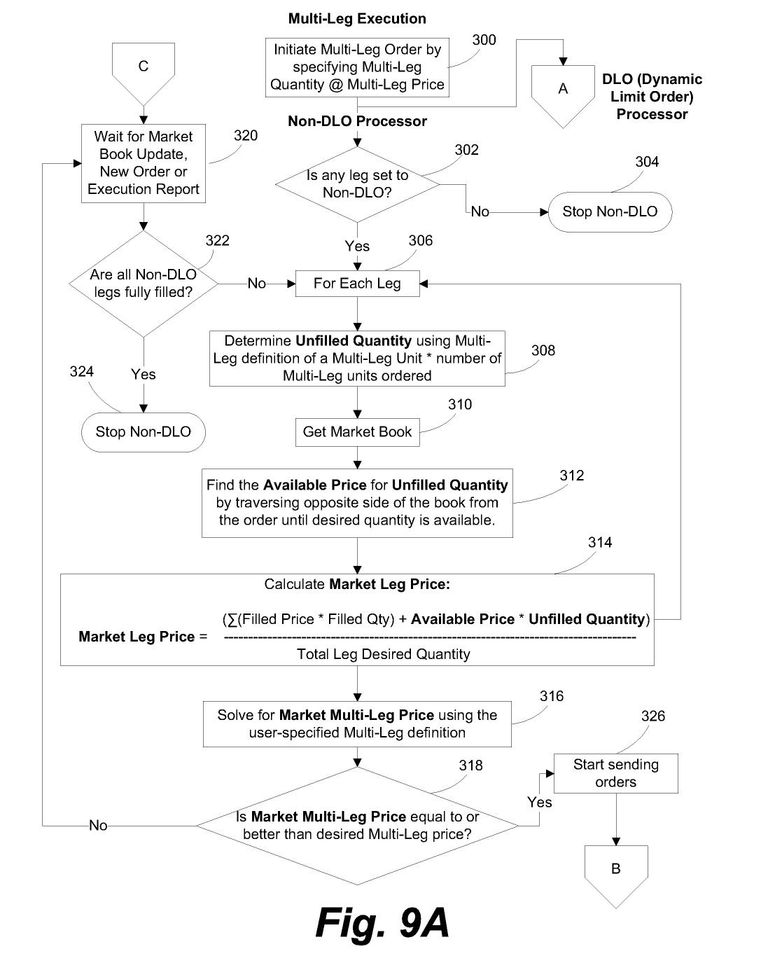

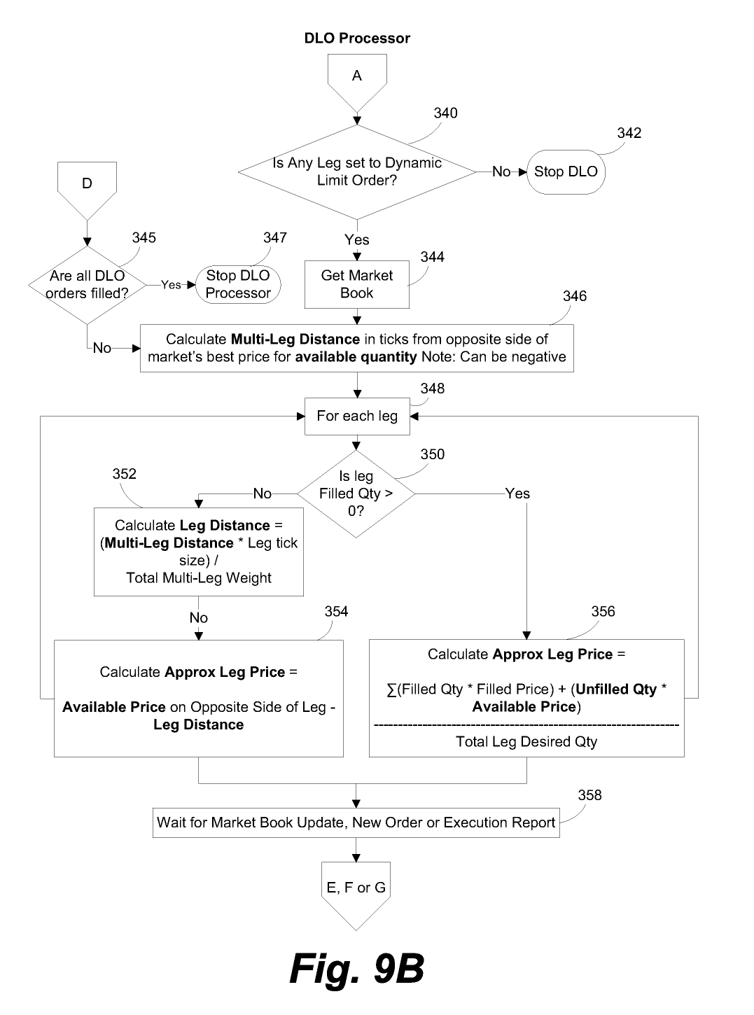

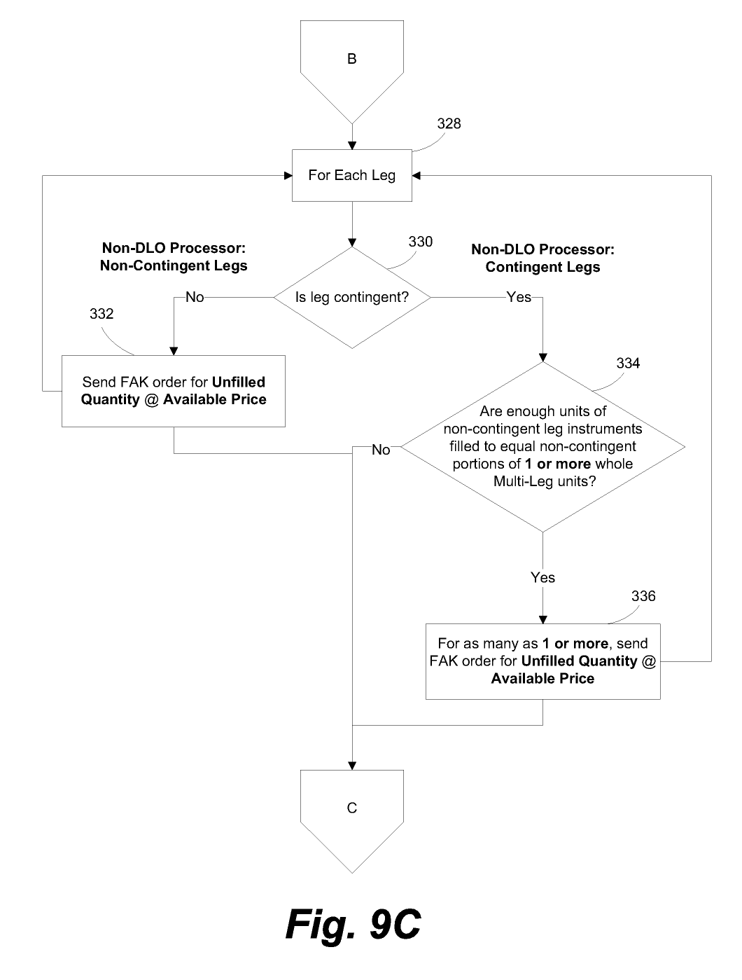

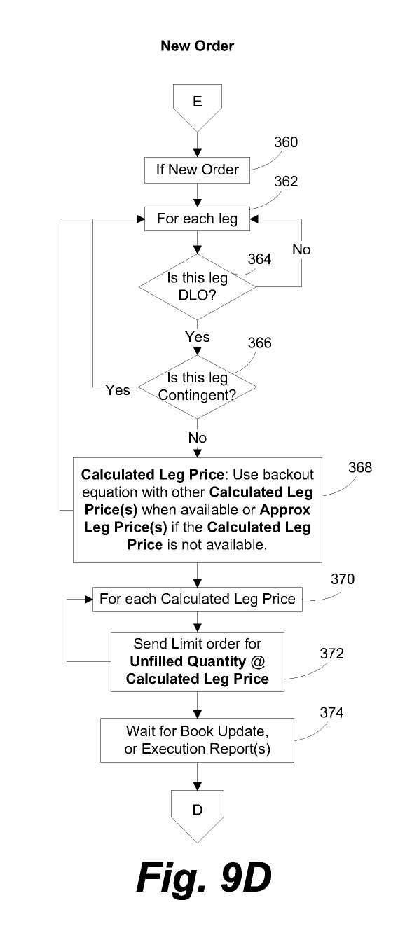

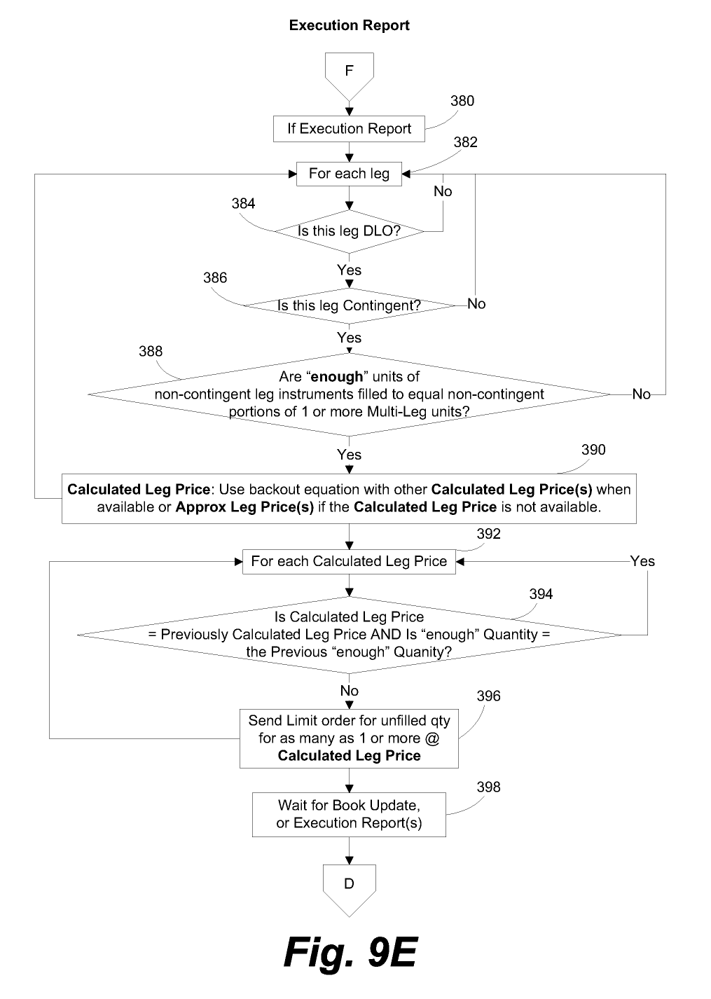

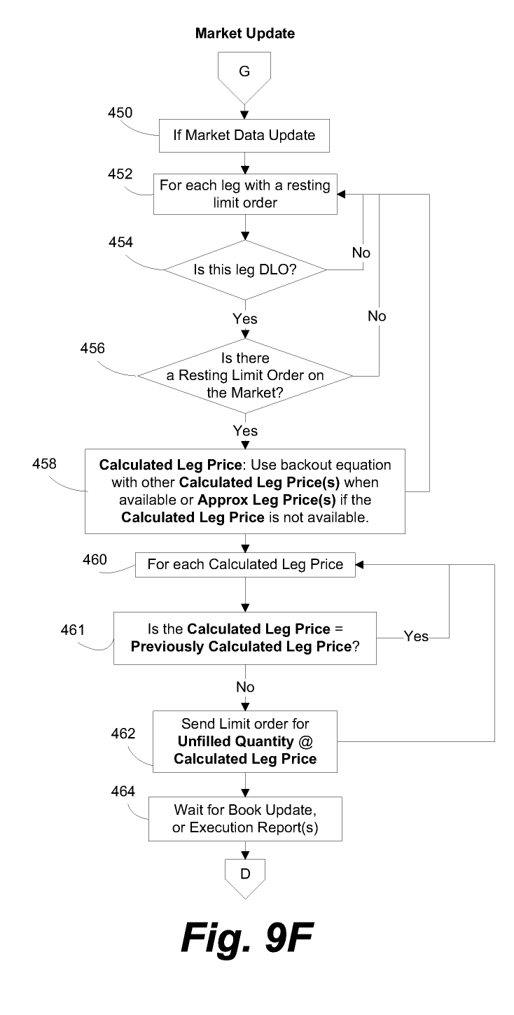

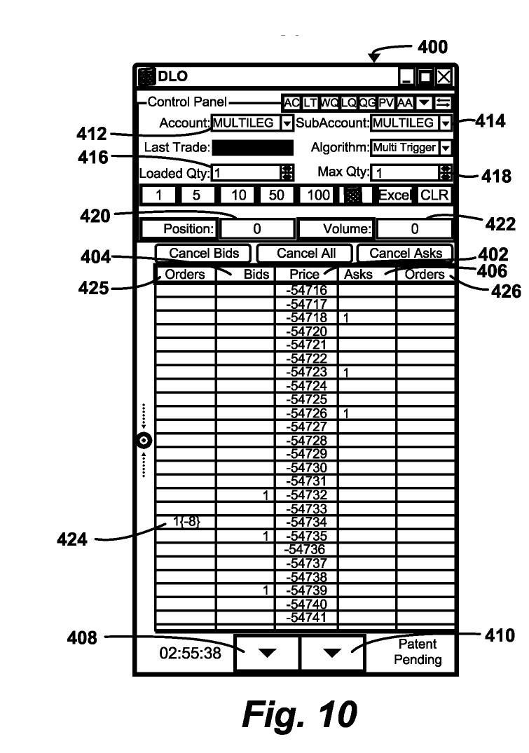

Multi-leg execution can be further understood with reference to the flow diagram of FIGS. 9A-9F. The trader initiates execution of the multi-leg instrument by placing a multi-leg order for a specified synthetic multi-leg price and for a specified multi-leg quantity 300. In a preferred embodiment, this is accomplished by use of the multi-leg trading ladder shown in FIG. 10, as described more fully below. The execution process proceeds along two leg execution paths, including a DLO (Dynamic Limit Order) path (beginning in FIG. 9B) for executing legs that are configured for dynamic re-pricing, and a non-DLO path (beginning in FIG. 9A) for executing legs that are not configured for dynamic re-pricing. As discussed above, one or more legs may be configured for dynamic re-pricing (i.e., DLO) at column 224 of FIG. 4. The non-DLO leg execution process begins by checking to see whether any leg is not configured for dynamic re-pricing 302. If no legs are configured for non-dynamic re-pricing, the non-DLO portion of the multi-leg execution process is terminated 304. For each leg 306 that is not configured for dynamic re-pricing (i.e., a non-DLO leg), the execution process proceeds to determine an Unfilled Quantity for the leg using the multi-leg definition 308. The Unfilled Quantity will be equal to the total unfilled leg quantity for all units of the multi-leg instrument specified at step 300. The current market book for the leg instrument is obtained 310, and a current Available Price for the Unfilled Quantity is determined by traversing the opposite side of the book from the intended leg order until the Unfilled Quantity is available 312, taking the price where the needed quantity is found by summing each quantity at each price level starting at the inside market and traversing away from the market (up for Asks, down for Bids). The Available Price will be the worst price (i.e., highest for a Bid, lowest for a Sell) that must be paid in order to obtain the Unfilled Quantity. For example, if the leg has a “long” position with an Unfilled Quantity of 7, and there are 2 units of the leg instrument available on the Ask/Sell side of the book at a price of 100, 3 units available at a price of 101, and 8 units available at a price of 102, then the Available Price is 102 because the market book reflects that a trade order for the Unfilled Quantity of the leg instrument must be placed at a price of 102 in order to get all of the Unfilled Quantity filled. In this example, a limit order for 7 units of the leg instrument at a price of 102 is expected to result in 2 units filled at a price of 100, 3 units filled at a price of 101, and 2 units filled at a price of 102 with a VWAP (Volume Weighted Average Price) of 101 for the 7 units.

With the Available Price and Unfilled Quantity determined, a current Market Leg Price is calculated 314. In a preferred embodiment, Market Leg Price is determined according to the following equation:

$$Market Leg Price = \frac{( \begin{matrix}Σ ( Filled Price * Filled Qty ) + \\ Available Price * Unfilled Qty\end{matrix} )}{Total Leg Desired Qty}$$

This equation adds the sum of the product of any filled leg quantity(ies) and the price(s) paid with the product of the Available Quantity and the Unfilled Quantity, divided by the total desired quantity of the leg instrument. Total Leg Desired Qty is determined by multiplying quantity of multi-leg units specified at step 300 by the leg quantity value specified in column 218 of FIG. 4. After steps 306-314 have been performed for each non-DLO leg, a Market Multi-Leg Price is calculated using the trader-specified multi-leg definition and the Market Leg Price calculated for each non-DLO leg 316.

The non-DLO leg execution process compares the Market Multi-Leg Price with the desired multi-leg price 318 specified at step 300. If the current Market Multi-Leg Price is not equal to or more favorable than the desired multi-leg price specified at step 300, the process waits for a market book update, new trade order or execution report 320. When any of these events occurs, the process checks to see whether all non-DLO legs are fully filled 322. If not, the non-DLO leg execution process repeats from step 306. When all legs are fully filled, the non-DLO process stops 324. If there are still unfilled non-DLO legs remaining, the process starts again at step 306.

At step 318, when the current Market Multi-Leg Price is equal to or more favorable than the desired multi-leg price specified at step 300 (i.e., the market has crossed the multi-leg instrument), the process recognizes the market data as showing that each leg instrument is available at the desired quantity and a price that is sufficiently favorable to meet or best the synthetic multi-leg price specified at step 300. So the process starts sending trade orders for the non-DLO legs 326. At this point for each leg 328, the process determines whether the leg is contingent 330. A leg can be made contingent on any one or more requirements that must be met before a trade order for the leg instrument can be submitted to an exchange, and in this manner, the contingency requirements function as a leg submittal trigger. A typical example of a contingency is where the leg is made contingent on one or more other legs being fully filled. In this example, trade orders for the contingent leg cannot be submitted until the one or more other legs have been fully filled where “fully filled” means all leg quantity defined for a single multi-leg unit has been filled.

If the leg is found to be not contingent at step 330, an FAK (Fill And Kill) order is submitted to an electronic exchange for the Unfilled Quantity of the leg instrument at the Available Price 332. After FAK orders have been sent for all non-DLO legs that are not contingent, the process proceeds to step 320 and waits for a market book update, new order or execution report. For each leg found to be contingent at step 330, the process determines whether there are “enough” units of non-contingent leg instruments filled to equal all non-contingent portions of one or more whole multi-leg units 334. For example, if the multi-leg instrument includes 4 leg instruments, 2 of which are contingent on all non-contingent legs being fully filled, and 1 unit of the multi-leg instrument requires 5 units for each of the 2 non-contingent leg instruments, then the value of “enough” will be 5 units or more for each of the 2 non-contingent leg instruments. If each of the 2 non-contingent legs had filled quantities of 10 units, there would be enough filled quantity of the non-contingent leg portions for 2 multi-leg units. So, having a filled quantity of at least 5 units for each of the 2 non-contingent legs would meet the criteria of step 334, and the process would move to step 336. If either of the 2 non-contingent legs had filled quantities of less than 5 units (which is not enough non-contingent leg instrument fills to satisfy 1 unit of the multi-leg instrument), then the criteria of step 334 would not be met, and the process would proceed to step 320 and wait for a market book update, new order or execution report.

At step 336, for as many as the “1 or more” multi-leg units determined at step 334, the process submits an FAK order to an electronic exchange for the Unfilled Quantity at the Available Price. After FAK orders have been sent for all contingent non-DLO legs, the process proceeds to step 320 and waits for a market book update, new order or execution report.

With reference now to the DLO leg execution process beginning at the top of FIG. 9B, the process performs an initial check to determine whether any leg is configured for dynamic re-pricing/DLO 340. If not, the DLO execution process stops 342. Otherwise, the process proceeds to obtain the aggregated market book for the multi-leg instrument 344, from which a synthetic market book for the multi-leg instrument is created as previously discussed above and as further discussed below with reference to the multi-leg trading ladder of FIG. 10. While the step of obtaining market book data is shown at particular points in the flow diagram of FIGS. 9A-9F, it should be noted that market data may be obtained for both the DLO leg execution process and the non-DLO leg execution process, or any individual leg(s), at any point in time prior to when that data is needed.

Using the market data, the process calculates a Multi-Leg Distance, which is the number of ticks that separate the market's best price for the needed quantity on the opposite side of the book from the multi-leg order's price 346 as specified at step 300. For example, if the leg being processed at step 346 is designated as “long” at column 218 of FIG. 4, then the leg side of the book will be the Bid side and the opposite side of the book will be the Ask side. If the leg calls for 5 units of the leg instrument for each multi-leg instrument unit and only 1 unit of the multi-leg instrument was specified at step 300, then the Multi-Leg Distance is measured as the number of ticks that separate the best price for any quantity on the Bid side of the book from the market's best price for an available quantity of 5 on the Ask side of the book.

After calculating Multi-Leg Distance, the process proceeds to step 348 where for each leg, the process determines whether the leg's filled quantity is greater than zero 350 (i.e., whether the leg is partially or fully filled). If it is, an Approximate Leg Price is calculated at step 356 by the following equation:

$$Approx Leg Price = \frac{( \begin{matrix}Σ ( Filled Qty * Filled Price ) + \\ Unfilled Qty * Available Price\end{matrix} )}{Total Leg Desired Qty}$$

This equation adds the sum of the product of any filled leg quantity(ies) and the price(s) paid with the product of the Available Quantity and the Unfilled Quantity for the leg, divided by the total desired quantity of the leg instrument. Total Leg Desired Qty is determined by multiplying the leg quantity value specified in column 218 of FIG. 4 by the quantity of multi-leg units specified at step 300. If it is determined at step 350 that filled leg quantity is not greater than zero, steps 352 and 354 are preferably used to approximate a leg price. However, it should be noted that an approximate leg price can be calculated at step 356 in lieu of step 352-354. At step 352, the process calculates a Leg Distance by use of the following equation:

$$Leg Distance = \frac{( Multi \text{-} Leg Distance * Leg Tick Size )}{Total Multi \text{-} Leg Weight}$$

Total Multi-Leg Weight is the total number of units of the leg instrument needed to fully fill all units of the multi-leg instrument specified at step 300 specified in column 218 of FIG. 4.

An Approximate Leg Price is calculated at step 354 by the following equation: Approx Leg Price=Available Price on the opposite side of the book from the leg−Leg Distance

The result of this equation can be negative in cases where the multi-leg order was placed crossing the multi-leg market. After steps 348-356 have been performed for each DLO leg, an approximate leg price has been determined for each leg and the DLO process then proceeds according to the occurrence of an event—a market book update, new order, or execution report 358. For a new multi-leg order, the process proceeds as shown in FIG. 9D. If an execution report is received, the process proceeds as shown in FIG. 9E. If a market update is received, the process proceeds as shown in FIG. 9F.

Since a new order for the multi-leg instrument occurs only once (i.e., when the execution process is initiated at step 300), the process will complete the new order processing steps 360-374 only once. And the new order must be processed (steps 360-374) before any processing occurs after receiving an execution report (FIG. 9E) or market data update (FIG. 9F). After new order processing has occurred (steps 360-374), if an execution report and market data update are received concurrently, the execution report is given priority and processed according to steps 380-396 of FIG. 9E before the market data update is processed according to steps 450-462 of FIG. 9F.

Referring to FIG. 9D, if a new order has been placed for a multi-leg instrument 360, then for each leg 362, the process first confirms that the leg is a DLO leg 364 and not contingent 366 or else the process moves on to process the next leg. Once confirmed, a Calculated Leg Price is determined 368 for each confirmed leg using the appropriate backout equation specified at columns 226 and 228 of FIG. 4. If the trader has initiated a Bid order to buy one unit of the multi-leg instrument at step 300, the process uses the Bid backout equation defined in column 226 of FIG. 4 to determine the Calculated Leg Price. If the trader has initiated an Ask order to sell one unit of the multi-leg instrument, the process uses the Ask backout equation defined in column 228 of FIG. 4 to determine the Calculated Leg Price. Calculated Leg Price is determined for each non-contingent, DLO leg. Prices used in the backout equation preferably use the Calculated Leg Price of other legs if available. If no Calculated Leg Price is available for a leg, then the backout equation should use that leg's Approximate Leg Price. This is preferred because by using calculated instead of approximated leg prices, the relative price difference between legs is held constant. When the calculated values for other legs are used, the under-determined multi-variate equations become more determined in this way.

For each Calculated Leg Price determined at step 368, a limit order is sent for the Unfilled Quantity of the leg at the Calculated Leg Price 372. After all limit orders for all non-contingent DLO legs have been sent, the process waits for a book update or an execution report 374 and then checks to see whether all DLO legs have been filled 345. If all DLO legs are filled, the DLO leg execution process is terminated 347. Otherwise, the process moves to step 346.

If an execution report 380 is received at step 358, the process proceeds as shown in FIG. 9E. For each leg 382, the process first confirms that the leg is a DLO leg 384 and is contingent 386 as all non-contingent DLO legs are initially processed at steps 360-374 of the DLO leg execution process. Once confirmed, the process determines whether there are “enough” units of non-contingent leg instruments filled to equal all non-contingent portions of one or more whole multi-leg units 388. If there are not enough units filled at step 388, the process returns to step 382 and repeats. When enough units are filled, a Calculated Leg Price is determined 390 for the leg instrument using the appropriate backout equation specified at columns 226 and 228 of FIG. 4. If the trader has initiated a Bid order to buy one unit of the multi-leg instrument at step 300, the process uses the Bid backout equation defined in column 226 of FIG. 4 to determine the Calculated Leg Price. If the trader has initiated an Ask order to sell one unit of the multi-leg instrument, the process uses the Ask backout equation defined in column 228 of FIG. 4 to determine the Calculated Leg Price. Calculated Leg Price is determined for each contingent, DLO leg. Prices used in the backout equation preferably use the Calculated Leg Price of other legs if available. If no Calculated Leg Price is available for a leg, then the backout equation should use that leg's Approximate Leg Price.

Once all legs have a Calculated Leg Price, then for each Calculated Leg Price 392 determined at step 390, the process determines whether the Calculated Leg Price is equal to the immediately preceding Calculated Leg Price and whether there is “enough” filled quantity of non-contingent legs to equal one or more whole multi-leg units 394. If either condition is not true, this indicates that the current Calculated Leg Price does not equal the immediately preceding Calculated Leg Price or a contingency change occurred and adjustments to pre-existing resting limit orders must be made. If both conditions of step 394 are met, the process returns to step 392 and the next Calculated Leg Price for the next leg. If one or more conditions of step 394 are not met, a limit order is sent to an electronic exchange for the Unfilled Quantity of the leg for as many as the “1 or more” multi-leg units determined at step 388 at the Calculated Leg Price 396. After limit orders have been sent for all contingent DLO legs, the process waits for a book update or an execution report 398 and then checks to see whether all DLO legs have been filled 345. If all DLO legs are filled, the DLO leg execution process is terminated 347. Otherwise, the process repeats from step 346.

If a market data update 450 is received at step 358, the process proceeds as shown in FIG. 9F to determine whether any resting limit orders for DLO legs need to be adjusted. For each leg 452, the process first confirms that the leg is a DLO leg 454 and that there is a resting limit order on the market for the leg instrument 456. Once confirmed, a Calculated Leg Price is determined 458 for the leg instrument using the appropriate backout equation specified at columns 226 and 228 of FIG. 4. If the trader has initiated a Bid order to buy one unit of the multi-leg instrument at step 300, the process uses the Bid backout equation defined in column 226 of FIG. 4 to determine the Calculated Leg Price. If the trader has initiated an Ask order to sell one unit of the multi-leg instrument, the process uses the Ask backout equation defined in column 228 of FIG. 4 to determine the Calculated Leg Price. Calculated Leg Price is determined for each DLO leg having a resting limit order on the market. Prices used in the backout equation preferably use the Calculated Leg Price of other legs if available. If no Calculated Leg Price is available for a leg, then the backout equation should use that leg's Approximate Leg Price.

For each Calculated Leg Price 460 determined at step 458, the process determines whether the Calculated Leg Price is equal to the Previously Calculated Leg Price 461. If the new leg price is equal to the old leg price, the process returns to step 460 and processes the next leg. If the new leg price is different, the resting trade order for the leg is adjusted accordingly at step 462 by submitting a new limit order to an electronic exchange for the leg instrument at the new Calculated Leg Price for the Unfilled Quantity. After new limit orders have been sent for all DLO legs with resting limit orders, the process waits for a book update or an execution report 464 and then checks to see whether all DLO legs have been filled 345. If all DLO legs are filled, the DLO leg execution process is terminated 347. Otherwise, the process repeats from step 346.

The particular manner in which resting limit orders are adjusted at step 461 can vary in accordance with order entry/messaging policies dictated by each of the various exchanges. For example, some exchanges support a Cancel/Replace (CXR) order, and for those exchanges step 461 could be implemented by submitting a CXR order to a new price level. For exchanges that do not support CXR order messaging, step 461 might be implemented by submitting a Cancel order for the resting limit order(s) and submitting a new limit order at a new price. In-Flight Fill Mitigation (IFM) may be used if: (1) IFM is supported by the market center; (2) IFM per order is not supported or the available quantity is less than the requested quantity; and (3) the order has never been CXR'd or IFM was used the first time it was CXR'd.

It should be noted that for each step of the multi-leg execution process that involves calculating a leg price, the calculated leg price must take into account the price(s) (if any) at which the leg has been filled as well as the extent to which the leg has been filled because once a leg is filled (partially or fully) the fill price is fixed for those legs of the multi-leg instrument that have been filled and that fill price (or prices) becomes a fixed aspect of the multi-leg order processing strategy. To illustrate this by way of example, assume leg instrument CLX8 discussed above has received a partial fill for 2 of the desired 3 units of this instrument at a fill price of X. If the CLX8 leg instrument is partially filled and then re-priced at step 314, the Market Leg Price equation inherently weights the fill price by ⅔ and the new price for the remaining quantity of instrument CLX8 (i.e., 1) by ⅓. If each of the 2 filled units of CLX8 were filled at different prices, then the first fill price is weighted by ⅓, the second fill price is weighted by ⅓, and the new price for the remaining quantity is weighted by ⅓. All legs are re-priced in this manner based on weighted fill prices and fill percentages of any fully or partially filled legs.

In a preferred embodiment, the trader is presented with a graphical user interface (GUI) in the form of a multi-leg trading ladder 400, as shown in FIG. 10, from which execution of a synthetic multi-leg instrument may be launched at step 300 of FIG. 9A. Multi-leg trading ladder 400 includes a central price column 402 showing market prices for the multi-leg instrument as defined by the trader in FIG. 4. A Bids column 404 for displaying units of the multi-leg instrument available on the Bid side is positioned adjacent the left side of price column 402, and an Ask column 406 for displaying units of the multi-leg instrument available on the Ask side is positioned adjacent the right side of price axis 402. While the book depth for trading ladder 400 was defined in field 242 of FIG. 4 as “5”, it is noted that the book depth pictured in FIG. 10 is only 3. The remaining two levels of book depth can be viewed by scrolling the market data down or up using scroll keys 408, 410. Market data can also be scrolled using a keyboard's Page Up and Page Down keys, arrow Up and Down keys, or any other keys configured for scrolling the market data. Accounts/subaccounts through which the multi-leg instrument is to be traded are specified at Account field 412 and Subaccount field 414. Loaded Qty field 416 indicates to the trader the quantity of multi-leg units that will be traded with a single click. A Max Qty field 418 sets a limit on the quantity that can be loaded into the Loaded Qty field 416. In this manner, Max Qty field 418 functions to help ensure the trader does not inadvertently submit trade orders with extraordinarily high quantities. For example, by setting the limit in Max Qty field 418 to a value of “5”, the maximum value that can be placed in the Loaded Qty field 416 is “5”, which prevents the trader from inadvertently submitting a trade order with a quantity greater than 5 units of the multi-leg instrument. A Position field 420 shows the trader's current position, and Volume field 422 shows the volume traded during the trading session.

The trader may initiate execution of the multi-leg instrument in a number of ways, with or without a multi-leg instrument trading ladder. In a preferred embodiment, trading ladder 400 is configured to enable the trader to execute either a Buy or Sell of the multi-leg instrument by a single mouse click. To initiate execution, the trader simply places the mouse curser (or other onscreen pointer) at the desired synthetic price level and clicks the left mouse button (or other comparable user input device) to initiate a Buy of the multi-leg instrument at the moused-over/selected price level. To initiate a Sell of the multi-leg instrument, the trader right clicks at the desired price level. In FIG. 10, the trader has left clicked at synthetic price level −54734 (indicated at reference number 424) to place a Bid order for the multi-leg instrument at that price level. A Bids Orders column 422 shows that the trader has a resting order to buy 1 unit of the multi-leg instrument at the desired price level 424, and that this order is currently resting at 8 ticks below current market price as indicated by the notation “{−8}”. Right clicking at a desired price level that is above current market price (i.e., Best Bid or Best Ask, depending on side selected) will similarly place a resting order to sell 1 unit of the multi-leg instrument in Asks Orders column 426 at the selected price level. Based on the price level clicked at, processing device 106 proceeds to calculate leg prices for each leg instrument by solving the multi-leg definition as described above. Thus, when execution of the multi-leg instrument is initiated with use of trading ladder 400, the trader specifies a synthetic price for the multi-leg instrument and indirectly specifies a desired leg price for each leg instrument.

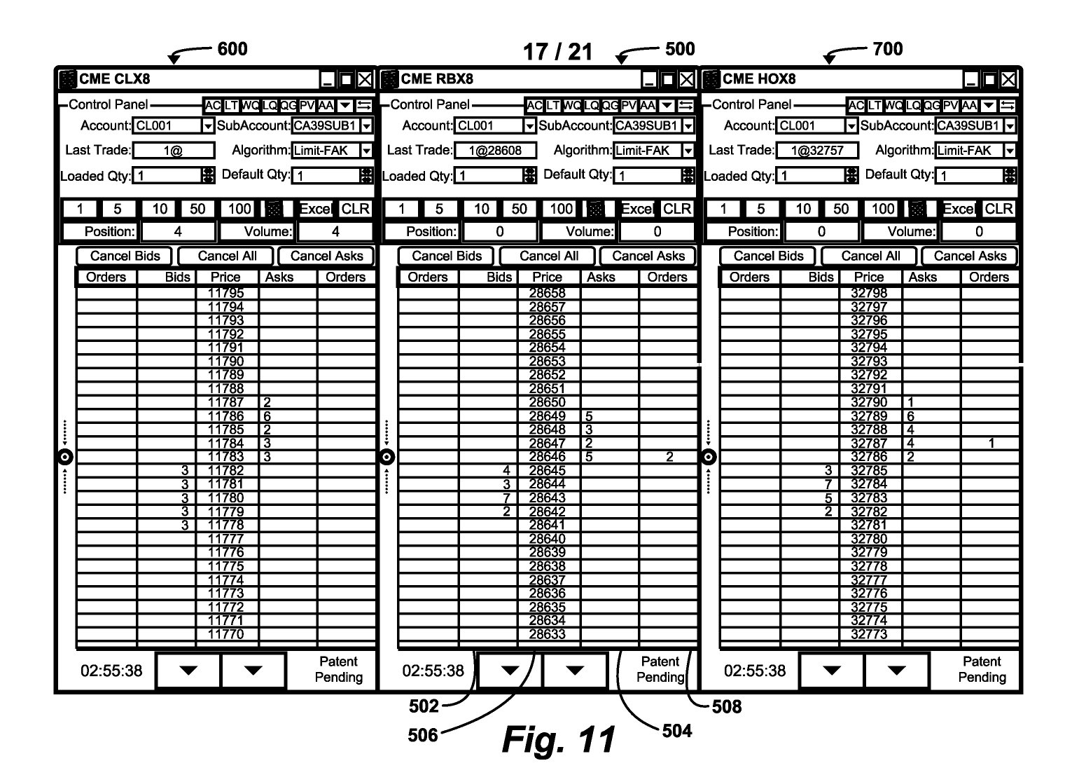

A look at the market data for each of the underlying leg instruments helps to illustrate how the multi-leg instrument definition and execution processes work. FIG. 11 shows a trading ladder 500 for leg instrument RBX8, a trading ladder 600 for leg instrument CLX8, and a trading ladder 700 for leg instrument HOX8. With reference to the multi-leg instrument and market data definitions set forth in FIG. 4, it is noted that the multi-leg instrument includes 2 units of financial instrument RBX8. FIG. 11 shows current market data for RBX8 in the form of resting Bids (Bids column 502) and resting Asks (Asks column 504) at price levels as indicated in Price column 506. Thus, 2 units of RBX8 can be sold at a best price level of 28645 and 2 units of RBX8 can be bought at a best price level of 28646. The multi-leg instrument also includes 3 units of instrument CLX8. The market data for instrument CLX8 shown in trading ladder 600 reveals that 3 units of CLX8 can be sold at a best price level of 11782, and 3 units of CLX8 can be bought at a best price level of 11783. Completing the multi-leg instrument is 1 unit of instrument HOX8. The market data for instrument HOX8 shown in trading ladder 700 reveals that 1 unit of HOX8 can be sold at a best price of 32785, and 1 unit of HOX8 can be bought at a best price level of 32786. The market data provided in FIG. 11 is used to resolve the Bid and Ask market data formulas set forth in windows 244 and 246, respectively, of FIG. 4.

Resolution of the market data formulas can be illustrated by solving the Bid formula (window 244), which is as follows:

### −2(CME.RBX8.ASK)+3(CME.CLX8.BID)−1(CME.HOX8.ASK)

Using Best Bid and Best Ask from the market data provided in FIG. 11 yields the following:

−2(28646)+3(11782)−1(32786)=−54,732

A “1” is placed in Bids column 404 of the multi-leg trading ladder 400 to indicate that 1 unit of the multi-leg instrument can be sold at a price level of −54,732. A “1” is also placed in Bids column 404 at a price level of −54,735 to indicate that a second unit of the multi-leg instrument can be sold at the −54,735 price level. The market data generation formula set forth in window 246 of FIG. 4 for the Ask side is similarly resolved from the market data for the leg instruments set forth in FIG. 1, as reflected by the quantities shown in Asks column 406 of FIG. 10. These Bid and Ask market data computations are carried out for the multi-leg instrument to a book depth of “5” as specified in field 242 of FIG. 4.

The multi-leg execution process described herein is also reflected in FIGS. 10 and 11. When the trader left clicked at price level -54,734 of FIG. 10, the execution process immediately submitted a resting Ask limit order for RBX8 at the desired leg price of 28,646 (as determined by the price level 424 clicked in the multi-leg trading ladder 400) and at a leg quantity of “2” (as determined by the value entered in Quantity column 220 of FIG. 4) since the leg for RBX8 is a non-contingent dynamically re-priced leg. The resting limit order can be seen in Asks Orders column 508 of the RBX8 trading ladder 500. In addition, the execution process placed a resting Ask limit order for HOX8 at the desired price of 32787 and at a leg quantity of “1”. No trade order has been submitted for leg instrument CLX8 since it is a non-contingent non-dynamically re-priced leg and the market has not crossed the resting limit order for the multi-leg instrument (as evident in FIG. 10). When the market for the multi-leg instrument crosses price level 424 of the multi-leg trading ladder 400, all legs are available at full leg quantity and desired leg price (or better), and an FAK limit order is submitted for 1 unit of the CLX8 instrument available at a desired leg price level.

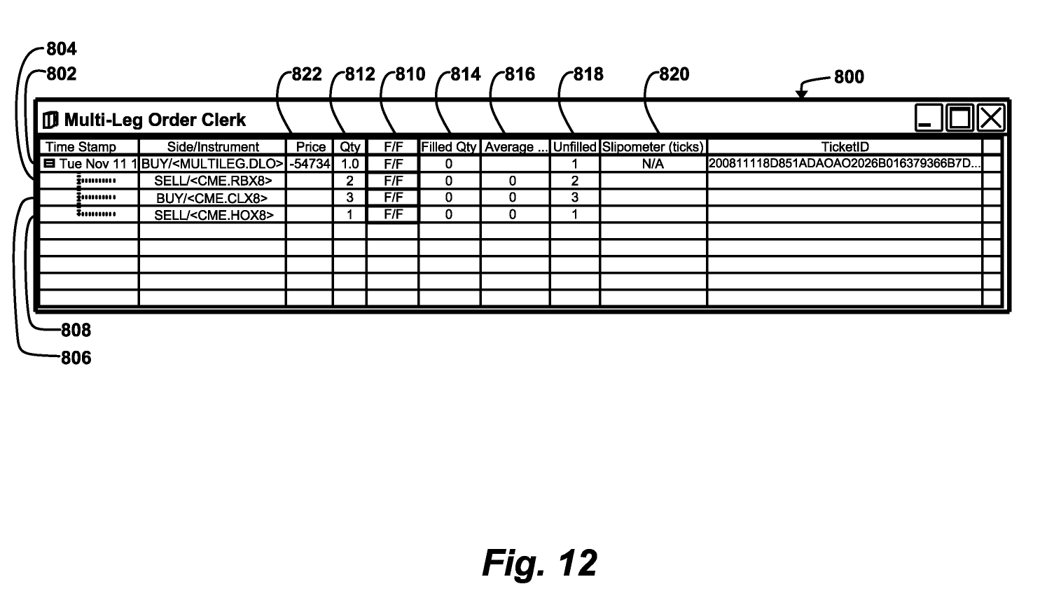

FIG. 12 shows a multi-leg order clerk 800 from which trade orders submitted for each of the leg instruments can be monitored and controlled. The order clerk 800 provides a useful tool for monitoring the synthetic multi-leg instrument and its legs. Trade orders for each leg instrument can be discretely submitted and filled from the order clerk 800 by clicking the fractional fill F/F button in column 810 associated with the appropriate row 802-808. F/F buttons 806 are particularly useful in situations where the multi-leg instrument has been fractionally filled and the trader wishes to obtain a fill on a remainder leg at the current market price. In such a situation, the trader may be looking to cap any loss (or prevent any further decrease in profit) by filling the remainder leg at current market price. Order clerk 800 also shows the trader the desired quantity in column 812, filled quantity in column 814, average fill price in column 816, and remainder quantity in column 818. A Slipometer™ column 820 shows slippage (in ticks) from the desired price shown in Price column 822.

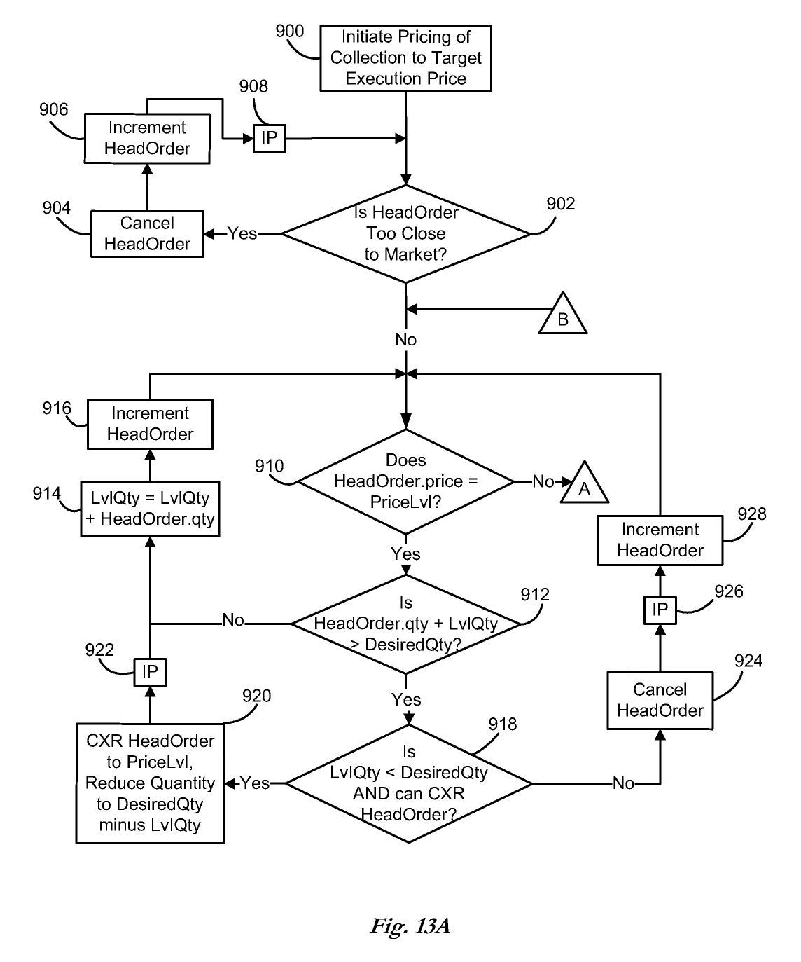

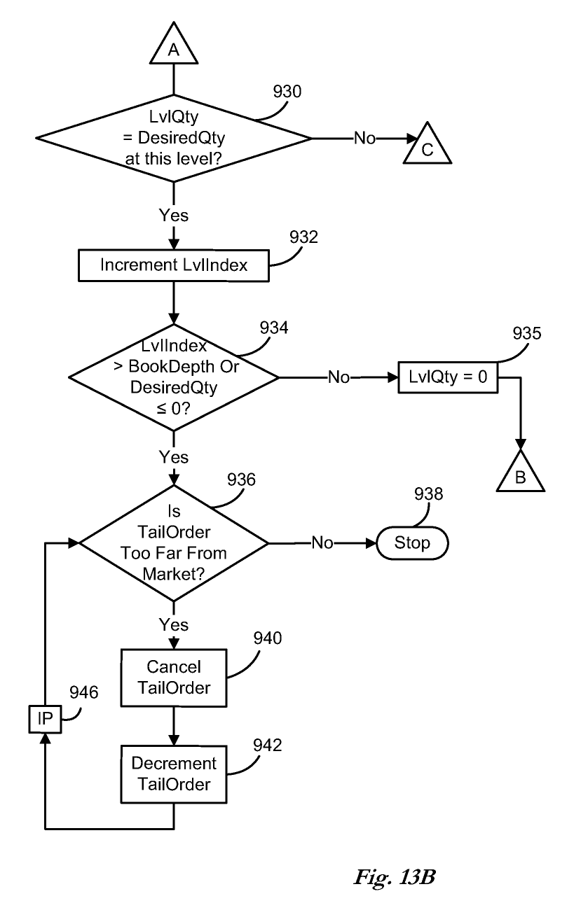

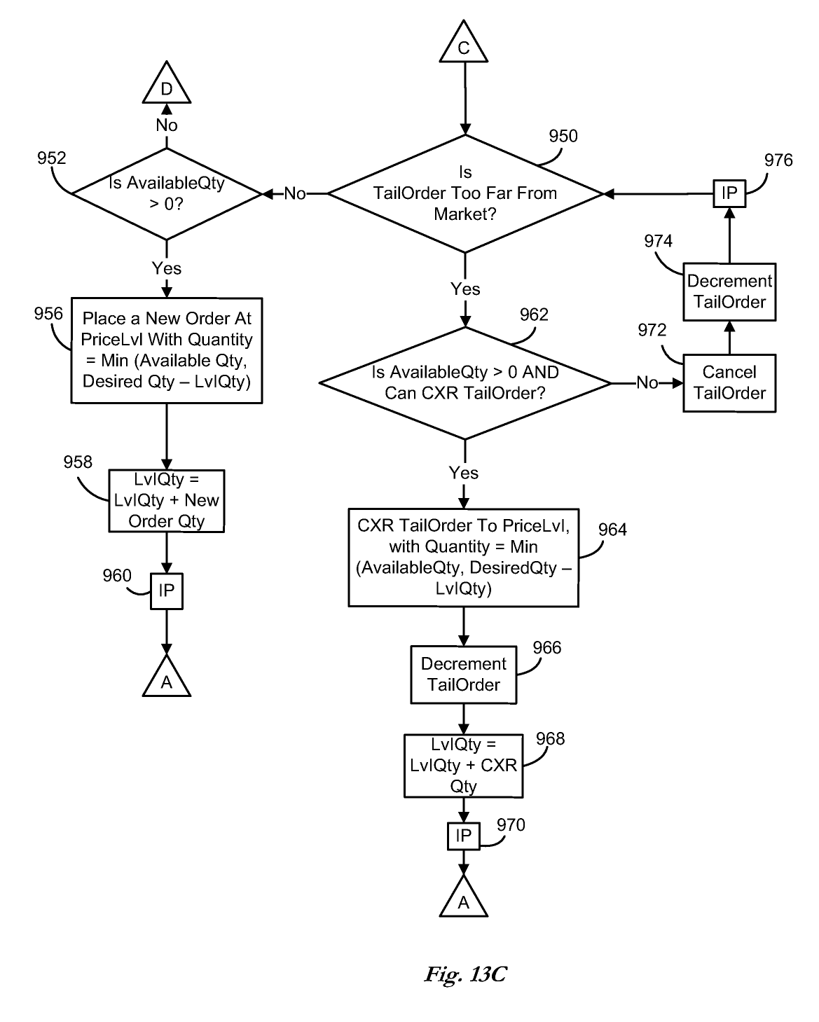

Dynamic re-pricing of one or more leg instruments has been described above as a useful option for multi-leg instrument execution. The concept of dynamic re-pricing may also be applied to both static and dynamic pricing/re-pricing of a collection of one or more trade orders for a trader seeking to acquire a position (long or short) in a security, get out of a position, make markets, etc. By “dynamic”, what is meant is that the pricing or re-pricing event is affected by changes in market conditions (such as a change in the market price or the receipt of an execution report) or a new pricing/re-pricing instruction (which itself may initiated in response to a change in market conditions). Through the employment of a clever trade order pricing and placement methodology as shown in FIGS. 13A-13C, a trader can obtain optimal fill prices without risk of being overfilled. The method is useful for pricing (both initial and re-pricing) a collection of one or more trade orders to one side (Bid or Ask) of the market center order book. It allows a trader to obtain a position (Long or Short) in a financial instrument, get out of a position, make markets, etc., in a way that maximizes queue priority and market liquidity while minimizing message-to-fill ratios.

The following terms are applied to the pricing method of FIGS. 13A-13C to help characterize a collection of one or more trade orders to which the method may be applied:
HeadOrder—the oldest trade order of the collection that is resting closest to the current market price level, and as such, is the first trade order of the collection to get filled in the event of a full book sweep
TailOrder—the newest trade order of the collection that is resting farthest from the current market price level, and as such, is the last trade order of the collection to get filled in the event of a full book sweep
TotalOrderQty—the total quantity of financial instrument units to be traded
BookDepth—the number of consecutive price levels at which trade orders of the collection are to be submitted (can be 1 or greater)
Target Execution Price—the least favorable price acceptable for all trade orders of the collection
MaxShow—the maximum quantity to be shown on the order book at each price level of the collection
FilledQty—the aggregate amount of the TotalOrderQty confirmed as being filled
RemainingQty—the difference between the TotalOrderQty and the FilledQty
DesiredQty—the lesser of MaxShow and RemainingQty minus MaxShow multiplied by the number of price levels away from the Target Execution Price
PendingQty—the maximum amount of the TotalOrderQty that has not been filled but could potentially get filled at any time, and includes the quantity of any trade orders of the collection for which a Cancel order is pending, and in the event In-flight Fill Messaging (IFM) is not available from the exchange/market center or is available but not utilized, further includes both the new and old quantity of any trade order of the collection re-priced via a pending CXR order less 1
LvlIndex—the number of price levels away from the market from the Target Execution Price (starts at zero for the Target Execution Price)
PriceLvl—the price at the current LvlIndex (starts at the Target Execution Price)
LvlQty—the aggregate quantity accounted for at the current price level
AvailableQty—the maximum new order size that can't possibly result in aggregate fills exceeding the TotalOrderQty, and is determined by RemainingQty minus PendingQty
IP—an optional “Interrupt Point” which immediately stops the pricing method if the pricing action has been interrupted, such as by a new pricing request with a new Target Execution Price or an order to cancel the collection

In general, the method of FIGS. 13A-13C proceeds in an iterative fashion, price level by price level, eliminating any quantity surplus at each price level of the collection and adding any quantity shortage that is needed so that for each price level of the collection, the total working quantity for trade orders of the collection is no less than and no greater than the desired quantity. The method can be repeated as many times as necessary until FilledQty equals TotalOrderQty, or until the collection is cancelled. In addition, the method is implemented in a way that ensures the collection will be filled at optimal prices and optimal message-to-fill ratios with no risk that the collection will be overfilled.

The method of FIGS. 13A-13C is initiated at step 900 when a pricing instruction is made (such as an instruction initiated by the user or an instruction that is automatically/programmatically initiated in response to an event such as receipt of an execution report for trade orders of the collection or receipt of data reflecting a new market price for the financial instrument) and proceeds to determine whether the HeadOrder (if there is one already resting on the order book) is too close to the current market price for the security 902. Preferably, the criteria for determining whether the HeadOrder is too close to the current market price is based on the Target Execution Price. If the HeadOrder is closer to the current market price than the Target Execution Price, then the HeadOrder is considered too close and cancelled 904. If there are two or more price levels containing such “too close” HeadOrders, then the trade orders resting at the price level that is closest to the market price are cancelled first. Regardless of the number of price levels containing “too close” trade orders, if there are multiple “too close” trade orders resting at the same price level, the HeadOrders at each price level are cancelled in order of age with the oldest of the “too close” HeadOrders resting at the same price level being cancelled first. Since the oldest trade orders working at the same price level have queue priority and are filled first, cancelling the oldest HeadOrders first minimizes the likelihood that a trade order that is too close to the market will be filled (such as in the event of a full book sweep) before it is cancelled.

Once the HeadOrder is cancelled, the next order in the collection away from the market becomes the new HeadOrder 906. Optionally, the method then checks at this point to see whether the pricing method has been interrupted 908, such as by a new pricing request with a new Target Execution Price or by an order to cancel the entire collection. If an interrupt event is detected, the pricing method is terminated. If no interrupt event has occurred, the method determines whether the new HeadOrder is too close to the market 902 and repeats the HeadOrder cancellation cycle (steps 902-908) until all “too close” HeadOrders have been cancelled.

After all too close HeadOrders have been cancelled, the method determines whether the price level of any remaining HeadOrder that is closest to the market is equal to PriceLvl 910, which starts at the current LvlIndex. If the HeadOrder price is equal to PriceLvl, the method proceeds to determine whether the sum of the HeadOrder quantity and the LvlQty (or LevelQty) is greater than DesiredQty 912. If this determination is negative, a new LvlQty is set to equal the sum of the current LvlQty plus the HeadOrder quantity 914, the HeadOrder is incremented to the next order in the collection 916 away from the market price, and the process returns to step 910. If the determination at step 912 is positive, the method then makes a two-part determination: (1) whether LvlQty is less than DesiredQty; and (2) whether it is possible to Cancel or Replace (CXR) the HeadOrder 918. The criteria for determining whether the HeadOrder can be CXR'd can vary. However, in a preferred embodiment the HeadOrder can be CXR'd only if it is in a “working” state and no CXR operation is currently pending for that order. If the HeadOrder can be CXR'd, a CXR order is submitted for the HeadOrder, reducing the quantity at the current price level to DesiredQty minus LvlQty 920. The method then optionally checks to see whether the pricing method has been interrupted 922. If an interrupt event is detected, the pricing method is terminated. Otherwise, the method proceeds to step 914.

If the HeadOrder cannot be CXR'd at step 918 or when LvlQty is greater than or equal to DesiredQty, the HeadOrder is cancelled 924. The method then optionally checks to see whether the pricing method has been interrupted 926. If an interrupt event is detected, the pricing method is terminated. Otherwise, the HeadOrder is incremented 928 away from market price and the method returns to step 910.

If the HeadOrder price is not equal to PriceLvl at step 910, a determination is made as to whether LvlQty is equal to DesiredQty at the current level 930. If it is, the LvlIndex is incremented away from market price to the next price level 932 and a two-part determination is made at step 934: (1) whether LvlIndex is greater than BookDepth; and (2) whether DesiredQty is less than or equal to zero. If neither determination is positive, LvlQty is reset to zero 935 and the method returns to step 910. If either determination is positive, the method will determine whether the TailOrder is too far from the current market price 936. If the TailOrder is not too far from market price, or if there is no TailOrder, the method stops 938. Preferably, the criteria for determining whether the TailOrder is too far from the current market price is based on the BookDepth (which can be either 1 price level or more). If the TailOrder is further from the current market price than the BookDepth, then the TailOrder is considered too far and removed 940. If CXR is supported by the exchange or other market center to which the order was submitted, the TailOrder is preferably removed by CXRing the TailOrder. If CXR is not available, the TailOrder is removed by cancelling the TailOrder. Once the “too far” TailOrder is removed, the TailOrder is decremented 942 such that the next order in the collection that is least likely to get filled in the event of a full book sweep becomes the new TailOrder. Thus, if the collection is on the Bid side, decrementing TailOrder will cause TailOrder to move up in terms of price level once all TailOrders at the current price level have been processed. If the collection is on the Ask side, decrementing TailOrder will cause TailOrder to move down in terms of price level once all TailOrders at the current price level have been processed.

If there two or more price levels containing “too far” TailOrders, then the trade orders resting at the price level that is farthest from the Target Execution Price are removed first. Regardless of the number of price levels containing “too far” trade orders, if there are multiple “too far” TailOrders resting at the same price level, the TailOrders at each price level will be removed in order from least likely to get filled (in the event of a full book sweep) to most likely to get filled. Since the newest of any TailOrders resting at the same price level have lower queue priority and are least likely to get filled, TailOrders resting at the same price level are removed from newest to oldest (reversed from the manner in which HeadOrders resting at the same price level are processed) in order to maximize the chance of getting the more favorably priced too far TailOrders filled. The method then optionally checks to see whether the pricing method has been interrupted 946. If an interrupt event is detected, the pricing method is terminated. Otherwise, the method loops back to step 936 and repeats until all TailOrders are cancelled.

With further reference to step 930, if LvlQty is not equal to DesiredQty, the method determines whether the TailOrder is too far from the market 950, preferably by applying the criteria described above with reference to step 936. If the TailOrder is not too far from the market, a determination is made as to whether AvailableQty is greater than zero 952. If AvailableQty is not greater than zero, the method returns to step 932. If AvailableQty is greater than zero, a new order is placed to increase quantity at the current PriceLvl with the order quantity being equal to the lesser of AvailableQty and DesiredQty minus LvlQty 956. At step 958, LvlQty is set to equal LvlQty plus the new quantity added to the current PriceLvl at step 956. The method then optionally checks to see whether the pricing method has been interrupted 960. If an interrupt event is detected, the pricing method is terminated. Otherwise, the method returns to step 930.

If at step 950 the TailOrder is determined to be too far from market, the method makes a 2-part determination: (1) whether AvailableQty is greater than zero; and (2) whether it is possible to Cancel or Replace (CXR) the TailOrder 962. Unless both determinations are positive, the TailOrder will be cancelled 972 and decremented 974 so that the next order in the collection toward the market becomes the new TailOrder. The method then optionally checks to see whether the pricing method has been interrupted 976. If an interrupt event is detected, the pricing method is terminated. Otherwise, the method returns to step 950.

If both determinations at step 962 are positive, a CXR order is submitted to cancel the TailOrder and replace it with an order at the current PriceLvl with quantity equal to the lesser of AvailableQty and DesiredQty minus LvlQty 964. The TailOrder is decremented 966 and LvlQty is set to equal LvlQty plus the CXR order quantity 968. The method then optionally checks to see whether the pricing method has been interrupted 970. If an interrupt event is detected, the pricing method is terminated. Otherwise, the method returns to step 930.

The method of FIGS. 13A-13C provides a unique approach at pricing (or re-pricing) a collection of trade orders to one side of an exchange order book that ensures the collection will be filled at optimal prices while ensuring the collection will not be overfilled in quantity. As can be seen, the method is initiated by receipt of an instruction to price a collection of one or more trade orders to one side of a market center order book. The method then generally proceeds to cancel all trade orders of the collection that are too close to the current market price, remove (CXR if available, or cancel) all trade orders of the collection that are too far from the Target Execution Price, and adjust the total quantity of financial instrument units at each price level of the BookDepth as needed so that the total quantity at each price level of the BookDepth is no greater than DesiredQty. The quantity at each price level of the BookDepth can be adjusted in a number of ways. For example, a price level of the BookDepth that includes too much quantity can be adjusted by cancelling any quantity that exceeds the lesser of AvailableQty and DesiredQty. A price level that contains too little quantity can be adjusted by placing a new order with a quantity that equals the lesser of AvailableQty and DesiredQty minus LevelQty. A price level with too little quantity can also be adjusted by submitting a Cancel or Replace (CXR) order with the new quantity for the CXR order being equal to this same quantity (i.e., the lesser or AvailableQty and DesiredQty minus LevelQty). The method may be repeated as many times as necessary until FilledQty equals TotalOrderQty, at which point the user will have acquired a desired position in the financial instrument or the order is cancelled.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A method for pricing and placing a collection of one or more trade orders for a financial instrument to one side of a market center order book, the method comprising:
receiving an instruction to price said collection of one or more trade orders to one side of a market center order book, wherein said collection is characterized by:
a Target Execution Price representing the least favorable price acceptable for all trade orders of the collection;
a TotalOrderQty representing the total quantity of financial instrument units to be traded;
a BookDepth representing the total number of consecutive price levels, beginning at the Target Execution Price, at which trade orders of the collection are to be submitted;
a MaxShow representing the maximum quantity to be shown on the order book at each level of the BookDepth;
a FilledQty representing the aggregate amount of the TotalOrderQty confirmed as being filled;
a RemainingQty representing the difference between the TotalOrderQty and the FilledQty;
a LevelQty representing a total of the quantity accounted for at the current price level;
a DesiredQty representing the lesser of MaxShow and RemainingQty minus MaxShow multiplied by the number of price levels away from the Target Execution Price;
a PendingQty representing the maximum amount of the TotalOrderQty that has not been filled but could potentially get filled at any time, and includes the quantity of any trade orders of the collection for which a Cancel order is pending, and in the event In-flight Fill Messaging (IFM) is not available from the market center, further includes both the new and old quantity of any trade order of the collection re-priced via a Cancel and Replace (CXR) order less one; and
an AvailableQty representing RemainingQty minus PendingQty; in response to said instruction:
cancelling all “too close” trade orders of the collection resting at a price level that is closer to the current market price than the Target Execution Price;
removing all “too far” trade orders of the collection resting at a price level that is farther from the Target Execution Price than the BookDepth; and
adjusting the total quantity of financial instrument units at each price level of the BookDepth, as needed, so that the total quantity at each price level of the BookDepth is no greater than DesiredQty.

2. The method of claim 1 wherein said removing step includes cancelling one or more such trade orders of the collection.

3. The method of claim 1 wherein said removing step includes CXRing one or more such trade orders of the collection.

4. The method of claim 1 wherein said adjusting step further comprises cancelling any quantity at each price level of the BookDepth that exceeds DesiredQty.

5. The method of claim 1 wherein said adjusting step further comprises increasing quantity at each price level of the BookDepth by an amount required to equal the lesser of AvailableQty and DesiredQty minus LevelQty.

6. The method of claim 1 wherein said step of cancelling all “too close” trade orders of the collection further comprises cancelling first those “too close” trade orders that are resting at the closest price level to the current market price.

7. The method of claim 6 wherein the oldest of any “too close” trade orders of the collection resting at the same price level are cancelled first.

8. The method of claim 1 wherein said step of removing all “too far” trade orders of the collection further comprises removing first those “too far” trade orders that are resting at the farthest price level from the Target Execution Pricel.

9. The method of claim 8 wherein the newest of any “too far” trade orders of the collection resting at the same price level are removed first.

10. The method of claim 1 wherein said adjusting step further comprises submitting a Cancel or Replace (CXR) order with the new quantity for the CXR order being equal to the minimum of MaxShow and AvailableQty.

11. The method of claim 1, further comprising repeating said receiving step, said removing steps, and said adjusting step until FilledQty equals TotalOrderQty or until the collection is cancelled.

12. The method of claim 1 wherein said instruction to price said collection of one or more trade orders is initiated upon receipt of a market update reflecting a new market price for the financial instrument.

13. The method of claim 1 wherein said BookDepth includes only 1 price level.

14. The method of claim 1 wherein said BookDepth includes a plurality of price levels.

15. A method for acquiring a position in a financial instrument by pricing and placing a collection of one or more trade orders for the financial instrument to one side of a market center order book, the method comprising:
submitting a collection of one or more trade orders for a financial instrument to a market center, each of said one or more trade orders being submitted to one side of the market center order book, wherein said collection is characterized by:
a Target Execution Price representing the least favorable price acceptable for all trade orders of the collection;
a TotalOrderQty representing the total quantity of financial instrument units to be traded;
a BookDepth representing the total number of consecutive price levels, beginning at the Target Execution Price, at which trade orders of the collection are to be submitted;
a MaxShow representing the maximum quantity to be shown on the order book at each level of the BookDepth;
a FilledQty representing the aggregate amount of the TotalOrderQty confirmed as being filled;
a RemainingQty representing the difference between the TotalOrderQty and the FilledQty;
a LevelQty representing a total of the quantity accounted for at the current price level;
a DesiredQty representing the lesser of MaxShow and RemainingQty minus MaxShow multiplied by the number of price levels away from the Target Execution Price;
a PendingQty representing the maximum amount of the TotalOrderQty that has not been filled but could potentially get filled at any time, and includes the quantity of any trade orders of the collection for which a Cancel order is pending, and in the event In-flight Fill Messaging (IFM) is not available from the market center, further includes both the new and old quantity of any trade order of the collection re-priced via a Cancel and Replace (CXR) order less one; and
an AvailableQty representing RemainingQty minus PendingQty;
if RemainingQty is greater than zero, receiving an instruction to re-price said collection of one or more trade orders to a new Target Execution Price;
in response to said instruction:
cancelling all “too close” trade orders of the collection resting at a price level that is closer to the current market price than the new Target Execution Price;
removing all “too far” trade orders of the collection resting at a price level that is farther from the new Target Execution Price than the BookDepth;
adjusting the total quantity of financial instrument units at each price level of the BookDepth, as needed, so that the total quantity at each price level of the BookDepth is no greater than DesiredQty; and
repeating said receiving step, said cancelling steps, and said adjusting step until FilledQty equals TotalOrderQty or until the collection is cancelled.

16. The method of claim 15 wherein said removing step includes cancelling one or more such trade orders of the collection.

17. The method of claim 15 wherein said removing step includes CXRing one or more such trade orders of the collection.

18. The method of claim 15 wherein said adjusting step further comprises cancelling any quantity at each price level of the BookDepth that exceeds DesiredQty.

19. The method of claim 15 wherein said adjusting step further comprises increasing quantity at each price level of the BookDepth by an amount required to equal the lesser of AvailableQty and DesiredQty minus LevelQty.

20. The method of claim 15 wherein said step of cancelling all “too close” trade orders of the collection further comprises cancelling first those “too close” trade orders that are resting at the closest price level to the current market price.

21. The method of claim 20 wherein the oldest of any “too close” trade orders of the collection resting at the same price level are cancelled first.

22. The method of claim 15 wherein said step of removing all “too far” trade orders of the collection further comprises removing first those “too far” trade orders that are resting at the farthest price level from the Target Execution Price.

23. The method of claim 22 wherein the newest of any “too far” trade orders of the collection resting at the same price level are removed first.

24. The method of claim 15 wherein said adjusting step further comprises submitting a Cancel or Replace (CXR) order with the new quantity for the CXR order being equal to the minimum of MaxShow and AvailableQty.

25. The method of claim 15 wherein said instruction to price said collection of one or more trade orders is initiated upon receipt of a market update reflecting a new market price for the financial instrument.

26. The method of claim 15 wherein said BookDepth includes only 1 price level.

27. The method of claim 15 wherein said BookDepth includes a plurality of price levels.

28. An apparatus for pricing and placing a collection of one or more trade orders for a financial instrument to one side of a market center order book, the apparatus comprising:
a graphical user display device;
a user input device;
a communication network for electronically communicating with one or more electronic market centers; and
a programmable electronic processing device in communication with the display device, user input device, and communication network, the electronic processing device being programmed to take the following actions in response to input received from the user input device:
submit a collection of one or more trade orders for a financial instrument to a market center, each of said one or more trade orders being submitted to one side of the market center order book, wherein said collection is characterized by:
a Target Execution Price representing the least favorable price acceptable for all trade orders of the collection;
a TotalOrderQty representing the total quantity of financial instrument units to be traded;
a BookDepth representing the total number of consecutive price levels, beginning at the Target Execution Price, at which trade orders of the collection are to be submitted;
a MaxShow representing the maximum quantity to be shown on the order book at each level of the BookDepth;
a FilledQty representing the aggregate amount of the TotalOrderQty confirmed as being filled;
a RemainingQty representing the difference between the TotalOrderQty and the FilledQty;
a LevelQty representing a total of the quantity accounted for at the current price level;
a DesiredQty representing the lesser of MaxShow and RemainingQty minus MaxShow multiplied by the number of price levels away from the Target Execution Price;
a PendingQty representing the maximum amount of the TotalOrderQty that has not been filled but could potentially get filled at any time, and includes the quantity of any trade orders of the collection for which a Cancel order is pending, and in the event In-flight Fill Messaging (IFM) is not available from the market center, further includes both the new and old quantity of any trade order of the collection re-priced via a Cancel and Replace (CXR) order less one; and
an AvailableQty representing RemainingQty minus PendingQty;
cancel all “too close” trade orders of the collection resting at a price level that is closer to the current market price than the Target Execution Price;
remove all “too far” trade orders of the collection resting at a price level that is farther from the Target Execution Price than the BookDepth; and
adjust the total quantity of financial instrument units at each price level of the BookDepth, as needed, so that the total quantity at each price level of the BookDepth is no greater than DesiredQty.

29. The apparatus of claim 28 wherein said processing device is further operable to adjust the quantity of financial instruments by cancelling, at each price level of the BookDepth, any quantity that exceeds DesiredQty.

30. The apparatus of claim 28 wherein said processing device is further operable to adjust the quantity of financial instrument units by increasing quantity, at each price level of the BookDepth, by an amount required to equal the lesser of AvailableQty and DesiredQty minus LevelQty.

31. The apparatus of claim 28 wherein said processing device is further operable to adjust the quantity of financial instrument units by submitting a Cancel or Replace (CXR) order with the new quantity for the CXR order being equal to the minimum of MaxShow and AvailableQty.

32. The apparatus of claim 28 wherein said processing device is further operable to remove all “too far” orders by cancelling one or more such trade orders of the collection.

33. The apparatus of claim 28 wherein said processing device is further operable to remove all “too far” orders by CXRing one or more such trade orders.

34. The apparatus of claim 28 wherein said processing device is further operable to remove first the oldest of any trade orders resting at the same price level.

35. The apparatus of claim 28 wherein said processing device is further operable to repeat said submit, cancel, remove and adjust actions until FilledQty equals TotalOrderQty.
